(19) United States
(12) Patent Application Publication
(10) Pub. No.: US 2018/0315059 A1
(43) Pub. Date: Nov. 1, 2018

(54) METHOD AND SYSTEM OF MANAGING ITEM ASSORTMENT BASED ON DEMAND TRANSFER

(71) Applicant: Target Brands, Inc., Minneapolis, MN (US)

(72) Inventors: RAMASUBBU VENKATESH, Minneapolis, MN (US); PARITOSH DESAI, Minneapolis, MN (US); BHARATH RANGARAJAN, Minneapolis, MN (US); APARUPA DASGUPTA, Minneapolis, MN (US); SHUBHANKAR RAY, Minneapolis, MN (US); LUYEN LE, Minneapolis, MN (US); SRIKANTH RYALI, Minneapolis, MN (US); VENKATARAMANA KINI, Minneapolis, MN (US); KASTURI BHATTACHARJEE, Minneapolis, MN (US); DEEPALAKSHMI GOPINATH, Minneapolis, MN (US); JESSE BERWALD, Minneapolis, MN (US)

(21) Appl. No.: 15/582,244

(22) Filed: Apr. 28, 2017

(51) Int. Cl. G06Q 30/02; G06Q 10/08; G06Q 20/20; G06Q 10/06

(52) U.S. Cl. CPC G06Q 30/02; G06Q 10/06375; G06Q 20/203; G06Q 10/087

(57) ABSTRACT

Methods and systems for managing an item assortment from among a collection of heterogeneous items are disclosed. One method includes receiving item data associated with the collection of heterogeneous items that defines values for a plurality of item attributes, and calculating a score for a degree of substitutability between items. A community detection algorithm is applied to edge weights that are based on the scores between items, to identify substitution groups among the items. Preferred attributes common to items within the substitution groups are found, and an item assortment is updated based on a determination of substitutability among items in at least one of the substitution groups.

### TECHNICAL FIELD

The present disclosure relates generally to managing item assortments, and analysis of demand transfer among items in item assortments.

### BACKGROUND

In various contexts, item assortments are selected in which various items can be presented to a user or population of users. The items in an item assortment are often selected to maximize the likelihood that any user viewing the item assortment will find a satisfactory item to select. This can be applied in various contexts in which a limited assortment of items is to be presented to a population of users for purposes of user choice. For example, item assortments can be found in retail environments, in the context of consumer or financial products, business-to-business sales, etc.

In such scenarios, there can be limitations with respect to the items that are included in such an item assortment. For example, in an online retail offering, a particular item assortment may be limited in terms of the numbers and types of items that are offered, because of a limit regarding practical storage space of either physical items or storage of data regarding the item in memory. Furthermore, for digital products, the storage space to hold a large number of digital items (e.g., digital content, such as movies, music, or other multimedia content) might be substantial as well. In a physical item assortment, particularly in a retail environment, the space requirements issue is exacerbated, because both an electronic record and physical inventory must be stored. Because of possible physical and electronic storage limitations, there is a practical limit to a number of items that can be included in such an item assortment.

Entities wishing to develop an item assortment will typically attempt to maximize the extent to which the item assortment includes an item that is “in demand” by a user. Accordingly, two items that are very similar to each other might not be maintained in the same item assortment if it can be determined that, from the perspective of potential users, those items are considered substantially interchangeable, or substitutes, of one another. Therefore, one of the two items might be able to be removed from an item assortment without substantially changing the extent to which users will find a satisfactory item within the item assortment (i.e., the remaining item being considered substitutable for the removed item). However, it can be difficult to determine the extent to which two items would be considered substitutable for one another. Existing attempts may simply assess two items and determine that, based on similarities of attributes among the items (e.g., price, brand, type of item, item qualities, etc.), the two items may be considered substitutable. However, these types of analyses do not necessarily work when comparing items across types of items, and often do not translate across brands. Accordingly, it can be difficult to accurately assess how user selections, or preferences, might change given changes to item selections.

Still further, optimizing, or improving, an item assortment can be made more difficult because items may change over time, may become unavailable, or new items may become available that represent a better fit within an overall item assortment. Accordingly, managing an item assortment is an ongoing process in which improvements are continually sought, and a static model is generally unsatisfactory.

In one example context, a product assortment (one type of item assortment described above) carried by a retailer at an online or “brick and mortar” store is able to be defined in terms of the breadth, the number of product categories carried, and depth, or number of products or SKUs in each of those categories. The retailer may have a number of locations, and may consider the potential customers at each location to be a different user population, or may consider users at all locations a relevant user population. In either case, the retailer may wish to adjust a product assortment offered to its customers. Because the number of items that can be included in a product assortment is not infinite (due to space and tracking logistics), it is often the case that, to add a new product to a product assortment, a different item must be removed. However, the retailer would not wish to remove a product for which customers do not perceive there to be an adequate substitute, because that retailer would then lose a possible sale of that product in a way that the sale would not be replaced by sale of that substitute item. This might be done on a per-location, or company-wide, basis. Such a retailer experiences many of the challenges outlined above, with a direct result being an effect on sales, either in terms of lost sales or sales redirected to lower margin products, or lowered customer satisfaction based on selection of an item perceived to be substitutable, but inferior.

### SUMMARY

In summary, the present disclosure relates to methods and systems for managing an item assortment based on analysis of demand transfer among items within the item assortment. Such demand transfer can be accomplished, for example, by assessing a selection history, such as a transaction history, sales history, or other type of item selection record, and determining a set of substitution groups based on both that selection history and item attributes. Within those substitution groups, substitutable items, and items having high or low demand, can be identified to allow for adjustment of the overall item assortment. Various aspects are described in this disclosure, which include, but are not limited to, the following aspects.

In one aspect, a method of managing an item assortment from among a collection of heterogeneous items is disclosed. The method includes receiving, at a computing system, item data associated with the collection of heterogeneous items, the item data defining values for a plurality of item attributes of the collection of heterogeneous items. The method further includes calculating, at the computing system, a score for a degree of substitutability between items within the collection of heterogeneous items, each item within the collection of heterogeneous items including a plurality of attributes defined in an item data collection and unique from other items within the collection of heterogeneous items. Calculating the score includes selecting a plurality of items from the collection of heterogeneous items for which transaction data exists, and calculating, at the computing system, an edge weight for each of a plurality of pairs of items, the plurality of pairs of items including each of the plurality of items relative to each other item within the plurality of items, the edge weight based on the transaction data. The method further includes applying a community detection algorithm to the edge weights to identify a plurality of substitution groups, and identifying preferred attributes common to two or more items within one of the plurality of substitution groups. Identifying the preferred attributes is performed by identifying preferred attributes common to the items in the substitution group, and identifying substitutable attributes of the items in the substitution group that are different. The method further includes updating an item assortment based at least in part on substitutability of the plurality of items within at least one of the plurality of substitution groups.

In another aspect, a system for managing an item assortment from among a collection of heterogeneous items is disclosed. The system includes a computing device including a processor, a memory communicatively coupled to the processor, and a content output device. The memory stores instructions executable by the processor to receive item data associated with the collection of heterogeneous items, the item data defining values for a plurality of item attributes of the collection of heterogeneous items, and calculate substitution scores between items within the collection of heterogeneous items based on transaction data associated with each item in the collection of heterogeneous items, each item within the collection of heterogeneous items including a plurality of attributes defined in an item data collection and unique from other items within the collection of heterogeneous items. The instructions further are executable to identify a plurality of substitution groups by applying a community detection algorithm to the substitution scores, identify preferred attributes and substitutable attributes of the items within the substitution groups based on the item data, and apply conditional regression to the items within the substitution group to determine a demand transfer coefficient for each item. The instructions further are executable to allow updates to an item assortment based at least in part on substitutability of the plurality of items within at least one of the plurality of substitution groups.

In yet another aspect, a non-transitory computer-readable storage medium comprising computer-executable instructions is disclosed which, when executed by a computing system, cause the computing system to perform a method of calculating a demand transfer coefficient for an item. The method includes receiving, at a computing system, item data associated with the collection of heterogeneous items, the item data defining values for a plurality of item attributes of the collection of heterogeneous items. The method further includes calculating, at the computing system, a score for a degree of substitutability between items within the collection of heterogeneous items, each item within the collection of heterogeneous items including a plurality of attributes defined in an item data collection and unique from other items within the collection of heterogeneous items. Calculating the score includes selecting a plurality of items from the collection of heterogeneous items for which transaction data exists, and calculating, at the computing system, an edge weight for each of a plurality of pairs of items, the plurality of pairs of items including each of the plurality of items relative to each other item within the plurality of items, the edge weight based on the transaction data. The method further includes applying a community detection algorithm to the edge weights to identify a plurality of substitution groups, and identifying preferred attributes common to two or more items within one of the plurality of substitution groups. Identifying the preferred attributes is performed by identifying preferred attributes common to the items in the substitution group, and identifying substitutable attributes of the items in the substitution group that are different. The method further includes updating an item assortment based at least in part on substitutability of the plurality of items within at least one of the plurality of substitution groups.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of an example network and system in which an item assortment can be managed based on demand transfer;

FIG. 2 illustrates an example block diagram of a computing system useable in the context of FIG. 1;

FIG. 3 illustrates a more detailed view of one example implementation of the computing system of FIGS. 1-2;

FIG. 4 illustrates a system in which an item assortment can be managed, using the networks and systems described herein;

FIG. 5 illustrates an example method of managing an item assortment based on demand transfer;

FIG. 6 is a flowchart of a method for adding a new item to an item assortment, according to an example embodiment;

FIGS. 7A-7B is a flowchart of a method for removing an item from an item assortment, according to example embodiments;

FIG. 8 illustrates one possible implementation of the system of FIG. 1 operating within a retail environment;

FIG. 9 illustrates one example of corresponding transaction data associated with sales of two items in a retail environment;

FIG. 10 illustrates a relationship between association scores and correlation scores based on example transaction data associated with an example item collection;

FIG. 11 is a chart illustrating association scores that are associated with specific attributes of two different items in an item collection, according to an example implementation;

FIG. 12 is a chart illustrating correlation scores that are associated with specific attributes of two different items in an item collection, according to an example implementation;

FIG. 13 is a chart illustrating a substitution group generated using association scores as applied to a product assortment in a retail environment;

FIG. 14 is a chart illustrating weights of attributes by attribute classifier as to membership in a substitution group;

FIG. 15 is a directed substitution graph illustrating demand transfer coefficients within the substitution group of FIG. 13;

FIG. 16 illustrates Pearson and Spearman correlation values, respectively, as compared to demand transfer coefficients as applied across all substitution groups, in an example implementation;

FIG. 17 illustrates a user interface depicting a rank aggregation of products within a substitution group, useable to modify the collection of items within an item assortment by adding or removing items from a particular substitution group;

FIG. 18 illustrates clustered items based on tokenized item name and attribute data, using an example data set;

FIG. 19 illustrates a correspondence between clusterings of items based on tokenized item name and attribute data and use of sales data for such clustering, as applied to an example data set of FIG. 18; and

FIG. 20 illustrates an item attribute based similarity graph derived from the data set of FIGS. 18-19.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general, the present disclosure relates to methods and systems for managing an item assortment based on analysis of demand transfer among items within the item assortment. Such demand transfer can be accomplished, for example, by assessing a selection history, such as a transaction history, sales history, or other type of item selection record, and determining a set of substitution groups based on both that selection history and item attributes. Within those substitution groups, substitutable items, and items having high or low demand, can be identified to allow for adjustment of the overall item assortment.

Although the concept of demand substitution and transferability is, at initial view, straightforward, discovering the substitution structure and quantifying the transfer of demand between a pairs of items in a category is a non-trivial task. Product heterogeneity within a category poses a major challenge. So does the stochastic and dynamic nature of demand. Trends and seasonality need to be addressed carefully. User or customer transactions in a category with product heterogeneity may make it difficult to infer substitutability of items. Users or customers often are proxy for households and this makes the disambiguation of preferences of individuals in the household and their substitution behavior from guest data a hard problem. Moreover, both item level demand and user transaction data are sparse and for those items with low or intermittent demand it is difficult to determine substitutability and estimate demand transfer coefficients with precision. Although product attributes can be important to understand substitution behavior, item attribute data is often also sparse and may often not capture the crucial attributes that reveal guest preferences.

In certain aspects of the present disclosure, item assortments can be classified in a variety of ways. One possible classification system places items into different categories. Categories may be defined at different levels of catalog hierarchy such as department, class, and subclass, in the case of a retail environment. The breadth, depth and composition of the product assortment are chosen to maximize a particular outcome associated with demand for specific items within a collection. For example, in a retail environment, revenue or gross margin might be maximized, while taking into account constraints such as a fixed financial budget, limited shelf space for displaying products, number of vendors needed for each product type, customer preferences and additional objectives such as having a certain percentage of assortment as product types. Such retailers might periodically review their assortment and make changes based on seasonality, trends, new item arrival, consumer tastes, local demographics and competition.

The present disclosure has advantages in the area of managing product heterogeneity. For example, a product category is defined as a group of products that consumers perceive to be interrelated and/or substitutable. Often even at the lowest level of hierarchy (class, department, etc.), the product selection is heterogeneous. The observed product heterogeneity even at a lower level of hierarchy is caused by the proliferation of product variants. To mitigate this, the present disclosure simplifies creation of new subcategories with more homogeneous set of products at these levels. Furthermore, the deseasonalization features described herein account for changes in demand over a particular period of time in which incentives may have been offered.

Furthermore, in general, behavior of users in selection of items from an item assortment can be complex in view of such an item assortment. For example, in a retail environment, when presented with the absence of a preferred product, a customer may or may not select another product within the item assortment. This decisionmaking process is complex. Customers may have formed an intent to buy a product, arrive at a retail location, and not find what they are looking for. Such customers may decide to substitute for what is available, or may substitute their current favorite to try something new in display, substitute under stock out condition for their preferred products, may simply choose between products on display, respond to lowering of price or a promotional offer on a premium product and substitute premium for store brand, or the reverse case when premium product returns to its original price. In addition, customer substitution for a pair of products may not be symmetric as customers may have strong preference for one product over the other.

Given the complex nature of assortment planning, entities presenting item assortments, in particular in the retail environment, face fundamental tradeoff between breadth and depth. In addition, tradeoffs between existing and new, seasonal and non-seasonal, local and national products also need to be addressed. The present disclosure presents a data-driven approach to determining substitution behavior based on analysis of transaction data as well as item attribute data, and determining substitution groups from such data.

In example aspects of the present disclosure, the analysis of transaction data allows for a determination of substitutability across items despite heterogeneity of a set of users associated with the transaction data. In other words, the users who select items from an item collection, and therefore generate transaction data representing historical item selections, have different item preferences and selections, as well as different perceptions regarding substitutability among items. The data-driven analysis described herein accommodates this variance among users, and improves probabilities that, as an item assortment is adjusted, instances in which users opt to not select any item are reduced.

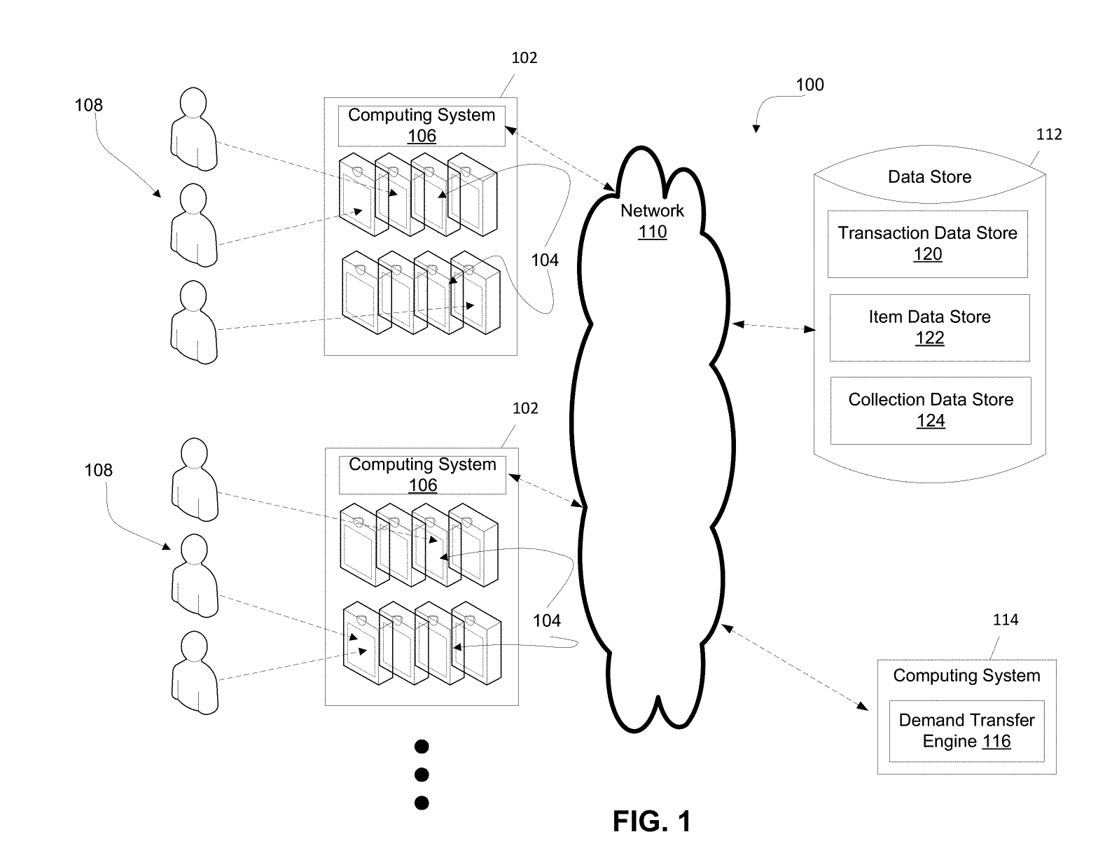

Referring first to FIG. 1, a diagram of an example system 100 in which an item assortment can be managed is illustrated. In the example shown, two locations 102 each include a plurality of items, representing an item collection 104. Although only two item locations 102, and therefore two item collections, are illustrated, it is understood that multiple item collections may be involved in the system, or only one item collection might be managed. In the context of the present disclosure, an item collection 104 can also be referred to as an item assortment. The item locations 102 can represent physical or virtual locations of items, e.g., a physical location such as a brick-and-mortar store, or a virtual location, such as an online marketplace.

A computing system 106 is associated with each item collection 104 and functions to record and report item data, transaction data, and collection data. The computing system 106 can take any of a number of forms. In the instance of an online item collection, the computing system can represent a server or cloud-based system that presents to users the item collection (e.g., via an application or web portal interface). In alternative instances, such as a physical item collection at a retail location, the computing system 106 can correspond to one or a plurality of computing systems (e.g., point-of-sale systems, inventory control systems, etc.) associated with the organization, at either a location or a collection of locations.

As illustrated in FIG. 1, a plurality of users 108 may select items at each location 102, thereby generating transaction data representing records regarding item selections at that location. As noted above, the plurality of users 108 represents a heterogeneous population of users having different views regarding substitutability of items within an item collection.

In the embodiment shown, the computing systems 106 at various locations 102 are communicatively connected via a network 110 to a data store 112, as well as to a computing system 114. The network 110 can be any of a variety of types of public or private communications networks, such as, for example, the internet.

In the embodiment shown, the computing system 114 includes a demand transfer engine 116. The demand transfer engine 116 receives data from the data store 112 to perform demand transfer analysis relative to one or more of the item collections 104. In example embodiments, the demand transfer engine 116 performs a demand transfer analysis, or substitutability, assessment, with respect to an item assortment. Such an analysis allows an entity managing the item assortment to improve overall demand, identify an improved selection of items to be included within an item assortment with respect to overall demand or substitutability, as described in further detail below.

As illustrated in the example depicted in FIG. 1, the data store 112 includes a transaction data store 120, an item data store 122, and a collection data store 124. Other types of information can be included in the data store 112 as well, such as different types of information associated with users or locations (e.g., user-specific or location-specific preferences), as well as seasonal trend information, localization information (e.g., popular items in particular locations), user demographic information, etc.

The transaction data store 120 includes transaction data, which describes selections made by users 108 from the item collections 104 at the various locations 102. In a retail environment, transaction data can include for example, a list of items purchased a number of different purchase transactions, the collections of items purchased together, prices paid for the items purchased, and various other information captured at a time of sale.

The item data store 122 stores item data that describes the attributes of items within an item collection 104, or for items considered for inclusion in an item collection. Item data can generally be more robust than transaction data with respect to the details included for a particular item, and can include full descriptive information for an item (e.g., brand, size, price, flavor, description, etc.).

The collection data store 124 contains collection data, which describes the number of different types of items and the number of each type of item in an item collection 104 at one or all locations 102. Collection data can include a set of information that is to be offered as part of an item collection to users, either at a particular location or locations, or from any/all locations of a particular item collection provider. As noted above, because item collections 104 might be maintained for a plurality of item locations, different sets of collection data may be maintained in the collection data store 124.

Although illustrated separately, the data store 112 can be managed using the computing system 114 or be in the same location as that computing system; however, there is no specific requirement for that to be the case. Rather, the data store 112 can be, for example, stored in cloud-based or distributed data center arrangements, and computing system 114 can similarly be implemented across a number of different possible hardware environments; examples of a possible computing system useable to implement the computing system 114 (and computing systems 106) are described in further detail below. Furthermore, although only one data store 112 and one computing system 114 are illustrated, it is understood that more than one such data store may be included in the system 100.

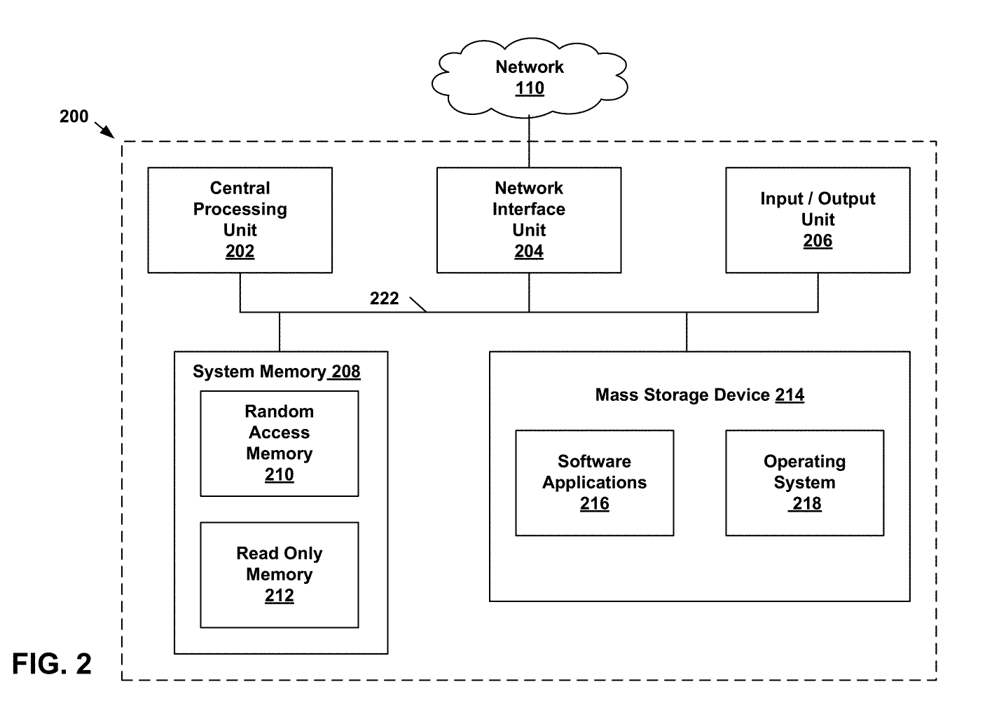

Referring now to FIG. 2, an example block diagram of a computing system 200 is shown that is useable to implement aspects of the system 100 of FIG. 1. The computing system 200 can be used to implement, for example, the computing systems 106 or 114 of FIG. 1, in example aspects.

In the embodiment shown, the computing system 200 includes at least one central processing unit (“CPU”) 202, a system memory 208, and a system bus 222 that couples the system memory 208 to the CPU 202. The system memory 208 includes a random access memory (“RAM”) 210 and a read-only memory (“ROM”) 212. A basic input/output system that contains the basic routines that help to transfer information between elements within the computing system 114, such as during startup, is stored in the ROM 212. The computing system 200 further includes a mass storage device 214. The mass storage device 214 is able to store software instructions and data.

The mass storage device 214 is connected to the CPU 202 through a mass storage controller (not shown) connected to the system bus 222. The mass storage device 214 and its associated computer-readable storage media provide non-volatile, non-transitory data storage for the computing system 200. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 202 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 200.

According to various embodiments of the invention, the computing system 200 may operate in a networked environment using logical connections to remote network devices through a network 110, such as a wireless network, the Internet, or another type of network. The computing system 200 may connect to the network 110 through a network interface unit 204 connected to the system bus 222. It should be appreciated that the network interface unit 204 may also be utilized to connect to other types of networks and remote computing systems. The computing system 200 also includes an input/output controller 206 for receiving and processing input from a number of other devices, including a touch user interface display screen, or another type of input device. Similarly, the input/output controller 206 may provide output to a touch user interface display screen or other type of output device.

As mentioned briefly above, the mass storage device 214 and the RAM 210 of the computing system 200 can store software instructions and data. The software instructions include an operating system 218 suitable for controlling the operation of the computing system 200. The mass storage device 214 and/or the RAM 210 also store software instructions, that when executed by the CPU 202, cause the computing system 114 to provide the functionality of the computing system 200 discussed in this document. For example, the mass storage device 214 and/or the RAM 210 can store software instructions that, when executed by the CPU 202, cause the computing system 200 to receive and analyze transaction data.

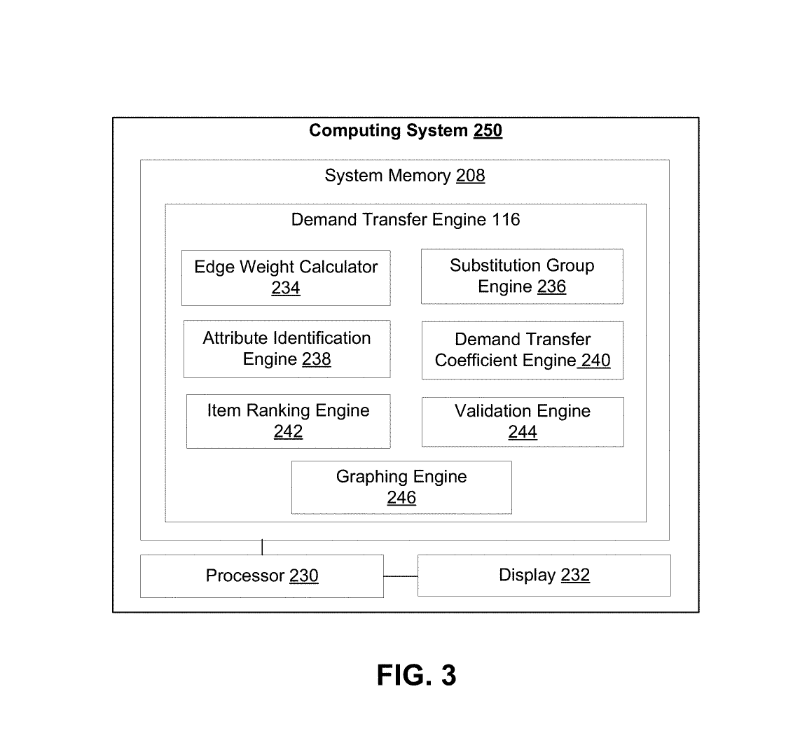

FIG. 3 illustrates a more detailed schematic diagram of a computing system 250, for example, as implemented when utilized as computing system 114 of FIG. 1. In the embodiment shown, the computing system 250 includes system memory 208, operatively connected to a processor 230. The computing system 250 also includes a display 232, also operatively connected to the processor 230 and system memory 208.

In the example embodiment shown, the system memory 208 includes a demand transfer engine 116. The demand transfer engine 116 includes an edge weight calculator 234, a substitution group engine 236, an attribute identification engine 238, a demand transfer coefficient engine 240, an item ranking engine 242, a validation engine 244, and a graphing engine 246. The various engines generally are implemented in software modules stored in the system memory 208, and are implemented as discussed in further detail below.

The edge weight calculator 234 is configured to calculate substitution scores between pairs of items within an item assortment. The substitution scores, or edge weights, measure the degree of substitutability between items with a collection of heterogeneous items. In one example implementation, the substitution scores are calculated by selecting a plurality of items from an item collection and utilizing transaction data (e.g., from the transaction data store 120) for those items to calculate edge weights for each pair of items with that collection. In some embodiments, the edge weight for a pair of items within the collection is calculated by using a correlation score calculated at least in part on a Pearson correlation between transactions associated with the pair of items. Such Pearson correlation scores can be normalized by correlating scores obtained in the presence of changes in item appearance, for example, based on item promotions. A weighted average of correlations, both including and excluding item promotions, can be used.

In other embodiments, the edge weight is calculated by using an association score. The association score is calculated at least in part on a probability that a transaction includes both first and second items within the pair of items divided by a product of first and second probabilities, where the first probability is the probability that a transaction includes a first item of a pair of items and the second probability is the probability that a transaction includes a second item of the pair of items that is different from the first item. Such an association score, designated as “AS” can be depicted as follows:

AS(item1, item2)=Probability user selected both item1 and item2

Probability user selected item1×Probability user selected item2

It is noted that this calculation may result in items having an edge weight of zero, for example based on (1) an item having no selections during a period of interest (e.g., due to the item recently being added, or being unpopular with users), (2) an item selected during the analyzed period, but which did not appear in transaction data used for evaluating association scores, or (3) an item that does not appear with any other item in a transaction history.

In still further embodiments, the edge weight calculator 234 can calculate edge weights between two items by using a Jaccard similarity score for each pair of items.

Although the edge weight calculator 234 can be executed using any of a variety of types of scoring mechanisms, it is noted that there is general correspondence seen among the correlation scores and association scores described above. Details regarding the extent of correlation between such scores are provided below.

The substitution group engine 236 is configured to identify substitution groups within an item assortment. The substitution groups are identified by applying a community detection algorithm to the edge weights calculated by the edge weight calculator 234. The community detection algorithm optimizes a modularity of the items based on the edge weights to identify the plurality of substitution groups. In one possible embodiment, the community detection algorithm can be applied as described in V. D. Blondel, J.-L. Guillaume, R. Lambiotte, and E. Lefebvre (2008), Fast unfolding of communities in large networks, the disclosure of which is hereby incorporated by reference in its entirety.

In accordance with the present disclosure, each substitution group includes one or more of the items from the collection of items. In some embodiments, the demand reflected in the transaction data is normalized to obtain residuals before substitution groups are identified. Normalization can take a variety of forms, but generally represents removal of effects on demand that are temporary or which would not carry forward into a projection on performance of a particular item assortment. Example normalization actions that can be taken in the retail context can include detrending and deseasonalizing the transaction data (e.g., removing seasonal effects and trend effects of particular periods of time that do not otherwise indicate a view of substitutability among items).

The attribute identification engine 238 is configured to identify attributes that distinguish each substitution group from other groups within an item assortment. For example, the attribute identification engine performs, for each substitution group, an identification of attributes common to all items within that identified substitution group as preferred attributes for the substitution group. The attribute identification engine 238 further performs, for each substitution group, identification of other attributes are considered substitutable attributes because they differ between the items within the substitution group, despite the items within the group being viewed as substitutable for one another. In some instances, as discussed below, an item attribute based similarity graph can be generated, in which item attributes, item name, and item description can be used to provide similarity scores useable as edge weights. Such edge weights can be used, in a community detection algorithm as discussed above, to find substitution groups for purposes of validating the substitution groups identified above.

The demand transfer coefficient engine 240 is configured to calculate demand transfer coefficients for each item within a substitution group. One method of determining demand transfer coefficients by the demand transfer coefficient engine 240 is based on association scores, when used.

In an example in the retail context where association scores are used, the various sets of customers who buy items A, S1, S2, C1, and C2 can be defined as illustrated below in Table 1, where items A, S1, and S2 fall within a common substitution group and C1, C2 are outside that substitution group:

TABLE 1
Association Scores Among Items Across Substitution Groups

| Item Pairs | Demand Transfer |
|---|---|
| (A,S1) | $\frac{f ( A , S1 )}{f ( A , S1 ) + f ( A , S2 ) + f ( A , C1 ) + f ( A , C2 )}$ |
| (A,S2) | $\frac{f ( A , S2 )}{f ( A , S1 ) + f ( A , S2 ) + f ( A , C1 ) + f ( A , C2 )}$ |
| (A,C1) | 0 |
| (A,C2) | 0 |
| (A,A) | $\frac{f ( A , C1 ) + f ( A , C2 )}{f ( A , S1 ) + f ( A , S2 ) + f ( A , C1 ) + f ( A , C2 )}$ |

By determining demand transfer coefficients based on the equations described in Table 1, above, a fraction of demand that will transfer from an item to another item within the assortment if the first item is removed can be determined.

In another example, the demand transfer coefficient engine 240 can use a conditional regression, i.e., to regress sales of an item in a substitution group against sales of all other items in that substitution group. The resulting model is an L1-regularized regression model where the model coefficient βᵢⱼ is proportional to the partial correlation between items i and j as explained in Pourahmadi, M. (2011), Covariance estimation: The GLM and regularization perspectives. Statist. Sci. 26 369-387, the disclosure of which is hereby incorporated by reference in its entirety. Partial correlations measure the degree of association or dependence between two random variables with the effect of a set of controlling random variables removed.

In particular, in this example, the demand transfer coefficient engine 240 can execute a regression according to the following equation:

$${y}_{i} = {\sum }_{i \neq j}^{ } {β}_{ij} {y}_{j} + {ɛ}_{i}$$

where yᵢ and yⱼ are daily transactions for items i and j respectively.

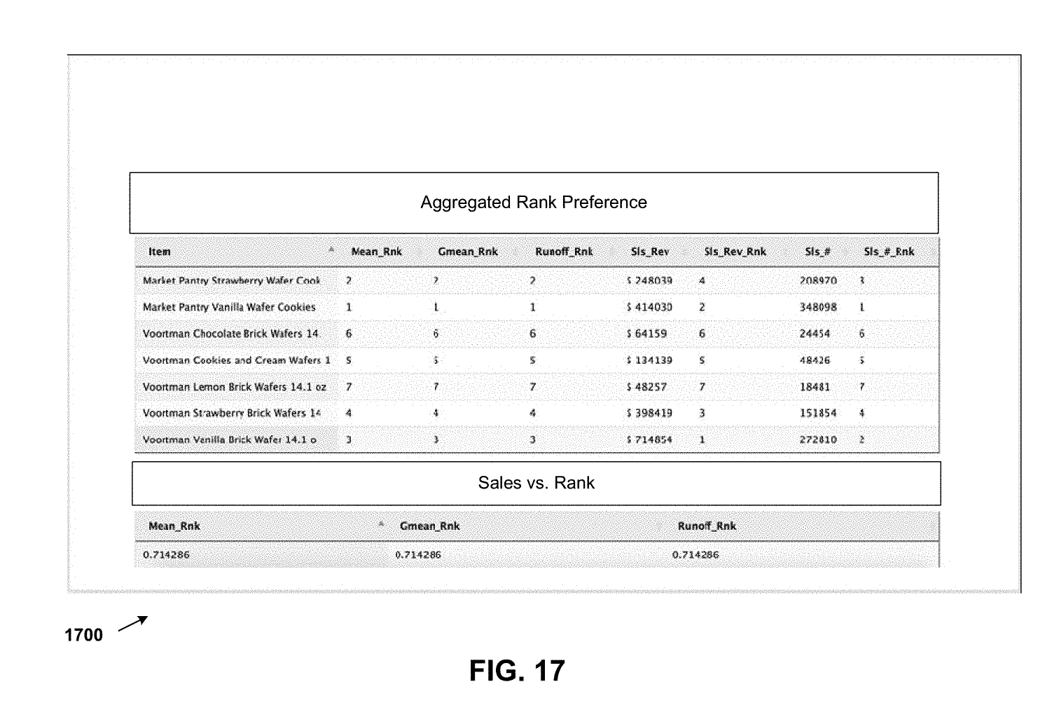

The item ranking engine 242 is configured to determine a rank order of preference of items with a substitution group for each of a plurality of users. For example, the item ranking engine 242 can develop a rank order based on transaction data, and can calculate an overall aggregate preference rank for the substitution group. The item ranking engine 242 can output an overall rank order as well, alongside specific attributes of that rank order (e.g., a basis for the calculation of rank order, as illustrated in the example of FIG. 17).

The validation engine 244 is configured to validate the calculated demand transfer coefficients, for example by diagnosing reliability of the above-described calculated demand transfer coefficients. The validation engine 244 can be implemented in a variety of ways. For example, the validation engine 244 can perform one or more validation techniques to improve accuracy of the calculated demand transfer coefficients, including use of, for example, bootstrapping, triangulation, and modularity metrics.

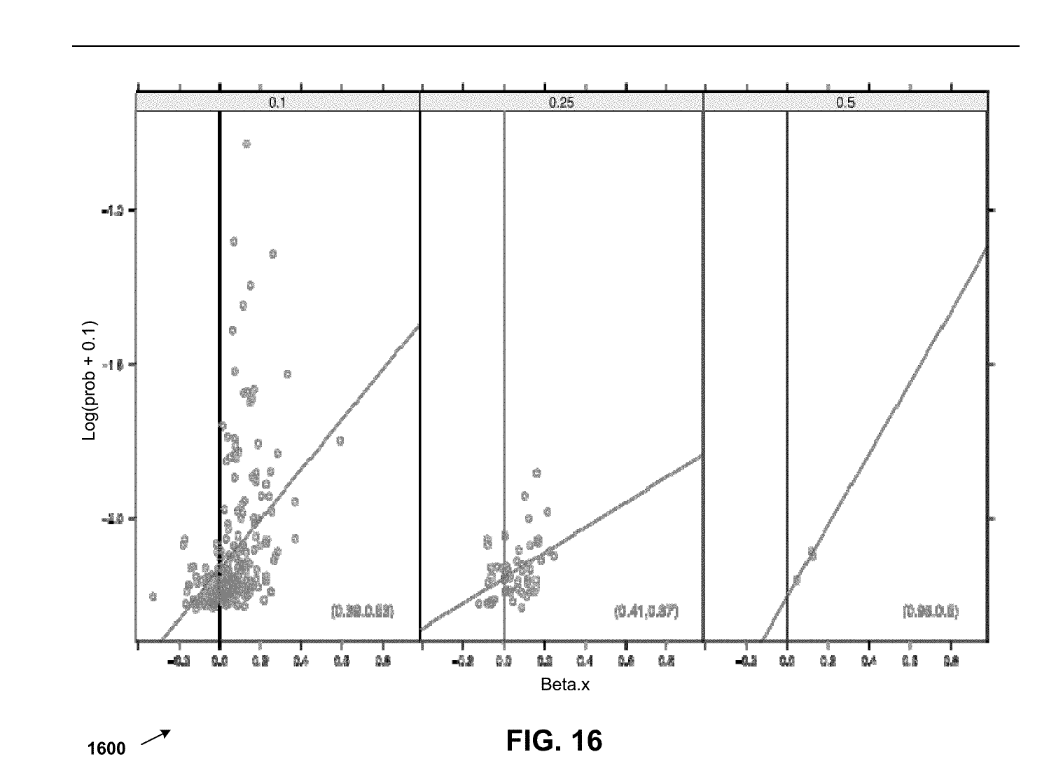

Regarding bootstrapping, the validation engine 244 can be configured to estimate an empirical distribution of association scores, and evaluate metrics that are indicators of reliability/stability between a given pair of items. For example, a random sampling of transaction data can have its association scores available for all items within that sampling, and a distribution created for every pair of items in the original sample. Bootstrap variance can be calculated to determine specific item associations that have a high degree of variance, which can be omitted from input to the graphing engine 246, described below. Example details regarding such a bootstrapping technique are provided in Efron B., Tibshirani R. J. (1993), An Introduction to the Bootstrap. Chapman & Hall, the disclosure of which is hereby incorporated by reference in its entirety. Details regarding a possible validation performed using the validation engine 244 are further described in connection with the retail examples described below, particularly in conjunction with FIG. 16.

Regarding triangulation, analysis can be performed by determining (1) user-level pairwise associations of demand (sales), (2) item-level estimate of pairwise correlation between detrended, deseasonalized demand (sales) of items and (3) proximity of substitutable items in attribute space.

Regarding modularity, in some embodiments, a modularity calculation can be performed based on determination of substitution groups using both association scores and correlation scores, to determine the quality of substitution groups discovered by community detection algorithms. In such an instance, the validation engine 244 can compare output from graphs generated from both scores to validate the accuracy of one or both scores.

The graphing engine 246 is configured to graph the substitutability score for each of the plurality of pairs of items within the collection of heterogeneous items. In some embodiments, the graphing engine 246 can generate a graph that is used to identify substitution groups. In other embodiments, the graphing engine 246 generates a graph that informs various decisions that are made regarding item assortment. Example graphs are illustrated in further detail below.

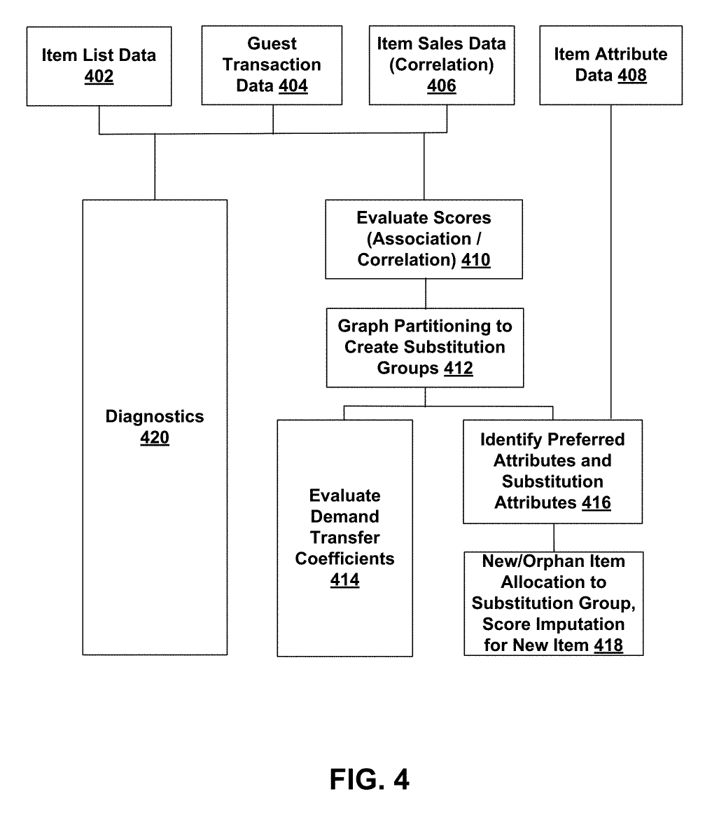

Using the computing system 250 of FIG. 3, an overall process flow can be accomplished as is seen in the overall system diagram of FIG. 4. The system 400 of FIG. 4 can be implemented, for example, across a computing system 114 and data store 112, or with the various computing systems of FIGS. 1-3.

In the example shown, the system 400 includes item list data 402, transaction data 404, item sales data 406, and item attribute data 408. The item list data 402 can, for example, represent an item list that was available at a time of transactions for purposes of determining how product substitution behavior occurred at a particular time. In some cases, the item list data 402 can represent a subset of an overall item collection, for example a portion of a collection for which demand transfer, or substitutability, is to be analyzed. For example, a particular department or category of products might be included in the item data 402. In a complementary manner, the transaction data 404 can, for example, represent one or more item collections that were selected during a common session during a predetermined period of time. The item sales data 406 represents item selection frequencies (e.g., “sales”) without associated purchase histories, while the item attribute data 408 includes a complete list of item and attributes that could be included in an item assortment or collection, as well as a collection of attributes for each item. Generally, item attribute data 408 will include many attributes for each item, and which may be heterogeneous set of attributes across item types. Item sales data 406 may include only a few attributes (e.g., size, price, and a brief description) as needed to uniquely identify the item.

In general, and as briefly described above, the item list data 402, transaction data 404, and item sales data 406 can be used to generate and evaluate edge weights in a scoring engine 410, based on a scoring among each pair of items in a given item list within the item list data 402, based on the transaction data 404 and item sales data 406. In general, for each pair of items, edge weights are calculated by either using an association score or correlation score, as described above in connection with the edge weight calculator 234 of FIG. 3.

Once edge weights are calculated, a partitioning operation 412 partitions a space into a plurality of substitution groups based on the edge weights. As noted above, a community detection algorithm can be applied. It is noted that, depending on whether an association score, correlation score, or Jaccard similarity index is used, different numbers of substitution groups might be formulated based on the transaction data. However, and as noted in the retail example below, a general correspondence between such scoring approaches is observed.

It is noted that in some embodiments, the partitioning operation 412 performs a graph partitioning, and can generate a visual representation of the partitioned area and substitution groups included therein. Examples of such a partitioned space, and associated substitution groups, are described below in connection with the retail example described herein.

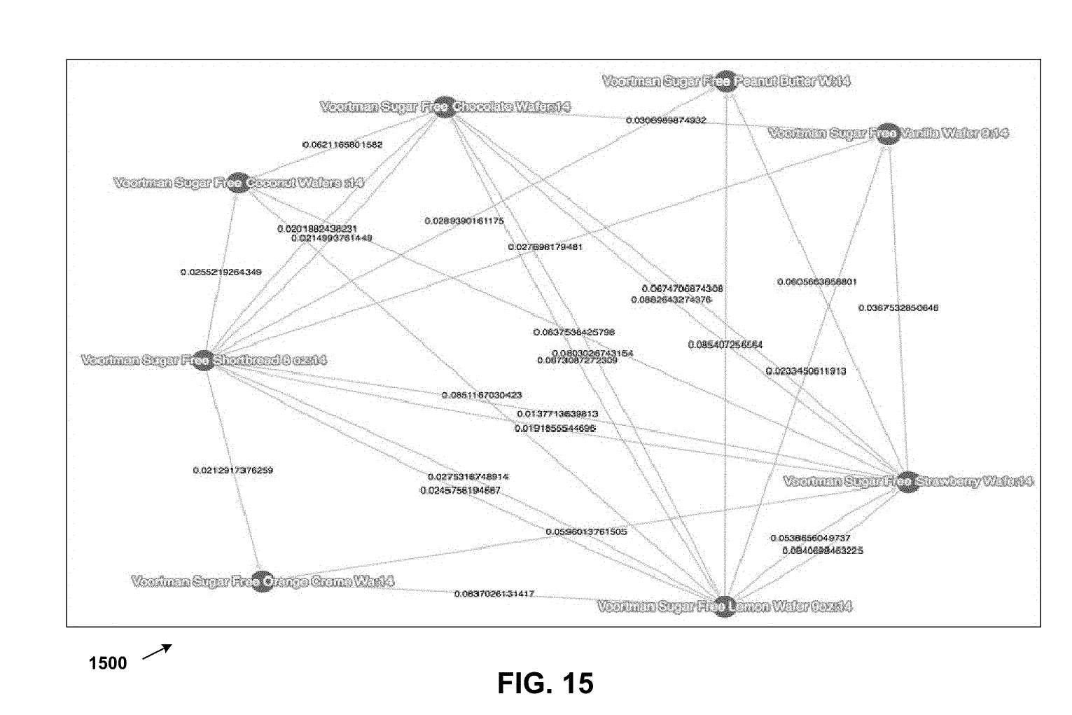

The substitution groups identified in the partitioning operation 412 can be used both (1) to evaluate demand transfer coefficients, in an evaluation operation 414, and (2) to identified preferred and substitution attributes in an attribute assessment operation 416. In example embodiments, the evaluation operation 414 determines demand transfer coefficients for each of the pairs of items given the edge weights between the items. The evaluation operation 414 does so using the association score or correlation score used to calculate the edge weights. In particular, the evaluation operation 414 can use association scores to calculate demand transfer coefficients within a substitution group according to the equations described in connection with Table 1, above, or can alternatively apply a Jaccard similarity index. Such a directed substitution analysis can result in a graph, such as that seen in the retail example of FIG. 15, below.

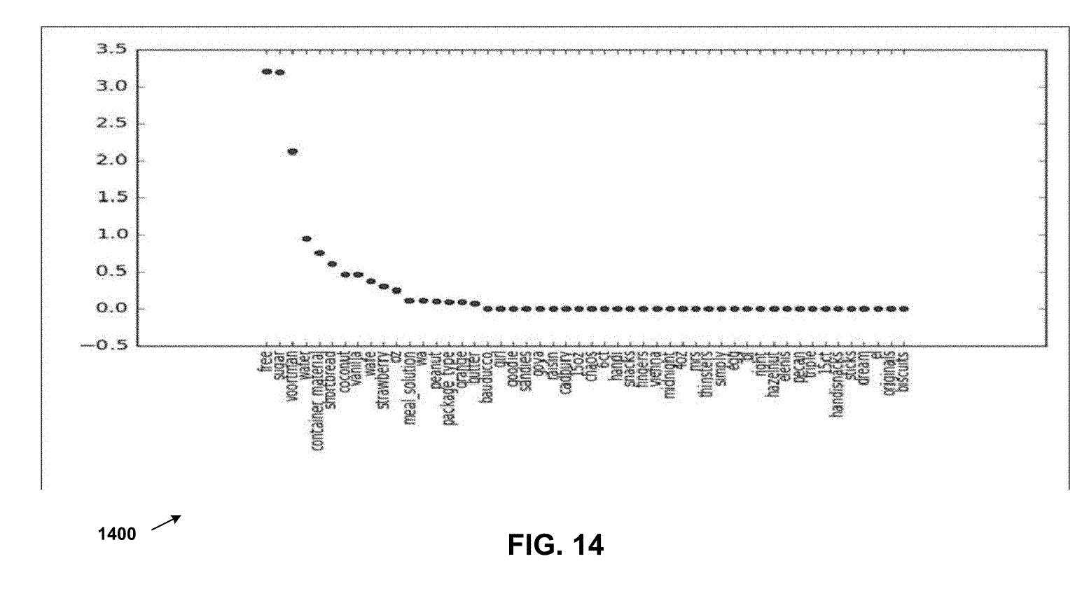

The attribute assessment operation 416 identifies, in a given substitution group, attributes of items that distinguish each group from other groups. For example, attributes that distinguish a group may be attributes that items within the group have in common, but which are different from attributes of items outside the substitution group. The attribute assessment operation 416 therefore merges the item attribute data 408 with the analyses of transaction data used to generate the substitution groups to assess a likelihood of substitutability among the items in such a substitution group. In the attribute assessment operation 416, the system 400 assesses structural and textual attributes associated with each item, and a one-vs-all classification is performed to determine the characteristics that distinguish one substitution group from the other groups. The attribute assessment operation 416 can further be used to create an item attribute based similarity graph in which item attributes, item name, and item description are used to determine similarity scores and provide edge weights. Such an item attribute based similarity graph could also be used to create or validate a substitution group. One example in the retail context of identifying such preferred and substitutable attributes is discussed in further detail below in connection with FIG. 14.

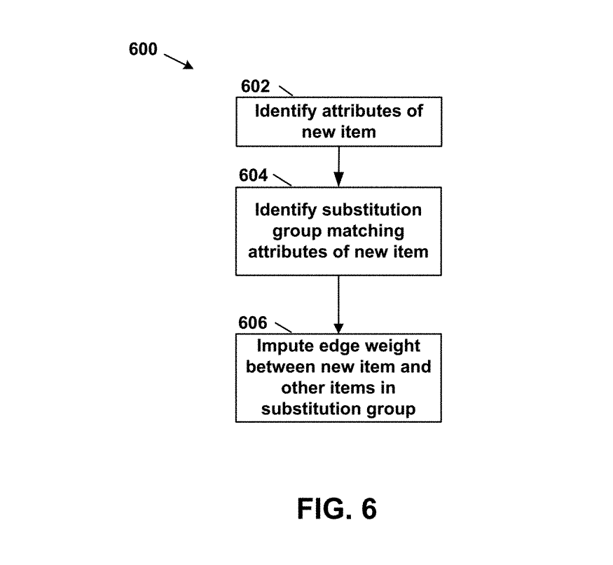

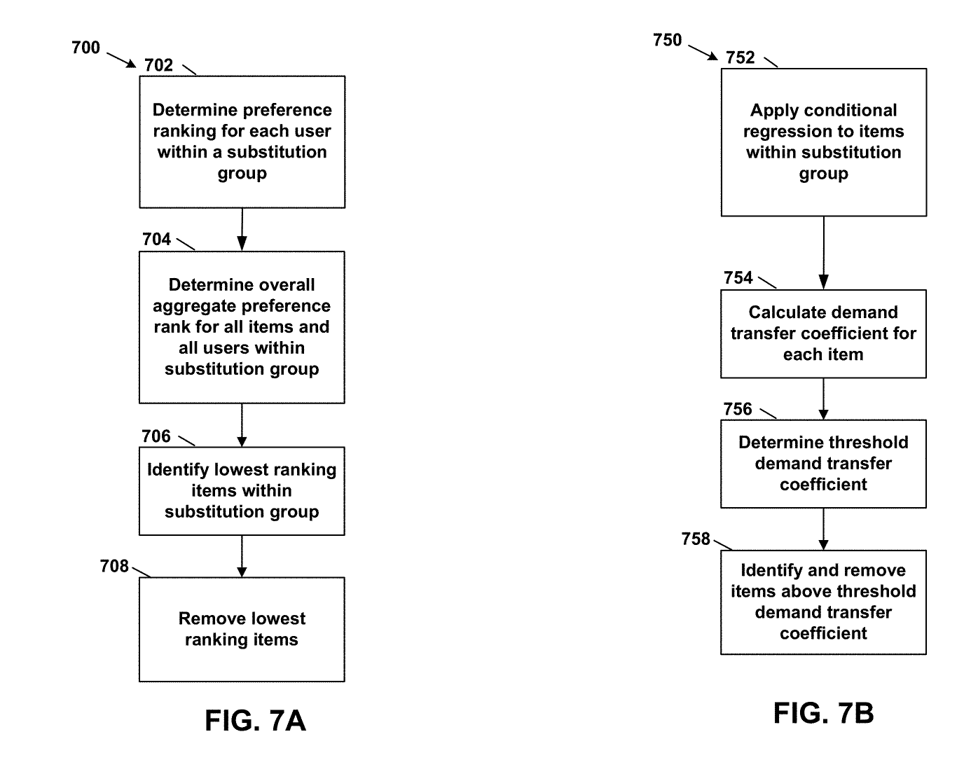

An item assortment adjustment operation 418 adjusts an item assortment, for example by calculating an overall effect of adding an item to or removing an item from a particular substitution group. The item assortment adjustment operation 418 can, in various embodiments, determine whether an item could be removed from an item assortment without a major detrimental effect to overall demand, or calculate an overall effect on demand of adding a new item to an item assortment. Details regarding adjustment of an item assortment, in particular with respect to adding or subtracting items, are described in further detail below in connection with FIGS. 6 and 7A-7B.

In addition, a diagnostics operation 420 performs diagnostics regarding the demand transfer analyses performed as discussed herein. The diagnostics operation 420 can include, for example, the bootstrapping and/or rank aggregation operations described herein.

In connection with the present disclosure, the systems of FIGS. 1-4 above present a number of potential advantages over other potential demand analyses. For example, the mathematical assessments performed using transaction data, and the discovery of substitution groups being performed entirely based on past data, avoids the requirement of other systems to introduce assumptions regarding substitutability of items based on item similarity, but instead relies on the data itself to make those substitutability determinations. Furthermore, the substitution groups that are generated according to the present disclosure allow for additional advantages, including

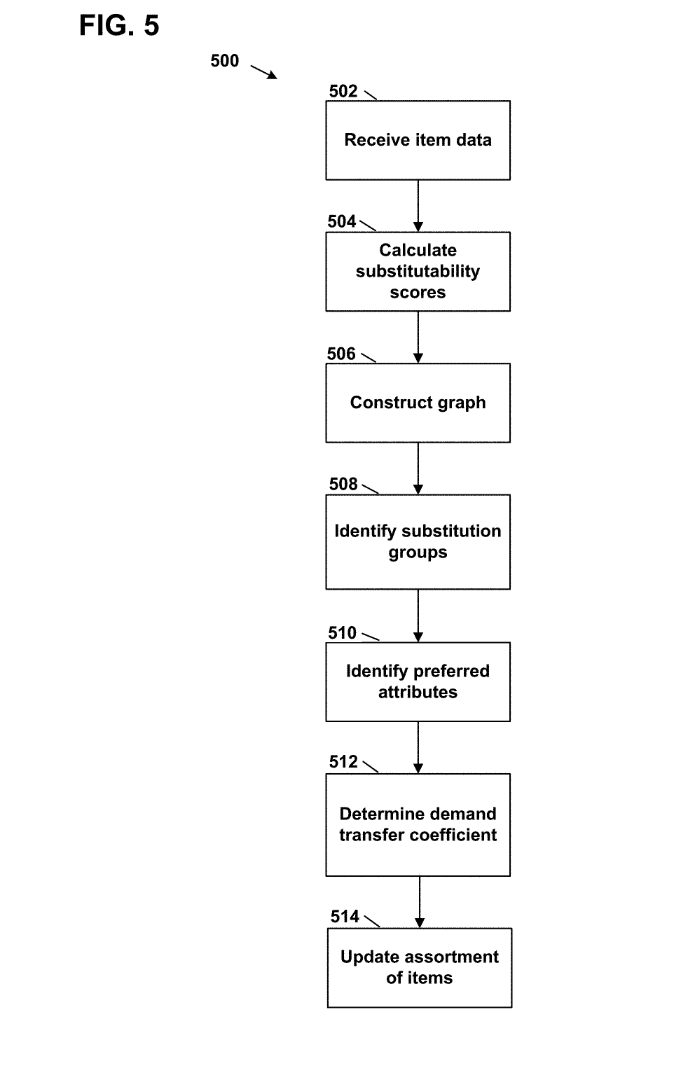

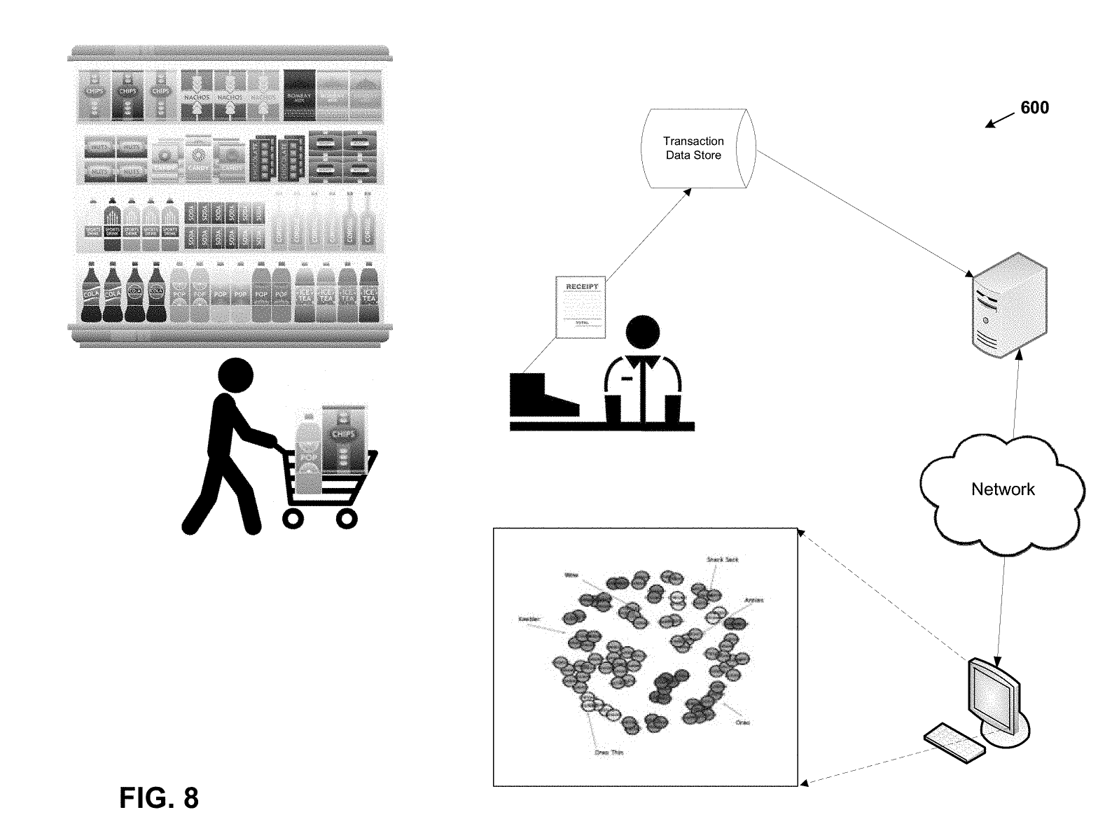

Referring now to FIGS. 5-7, flowcharts of methods that can be performed using the systems of FIGS. 1-4 are described. The methods described herein present possible operations that can be performed using these systems in a general case, while the detailed examples of FIGS. 8-17 present sample data that can be generated and analyzed using these methods and systems.

Referring now to FIG. 5, a flowchart for an example method 500 of managing an item assortment based on demand transfer is illustrated. The method 500 generally includes receiving item data associated with a collection of heterogeneous items at a computing system (step 502). The item data defines values for a plurality of item attributes of the collection of heterogeneous items. The computing system can be, for example computing system 114, 200, 250 of FIGS. 1-3.

The method 500 further includes calculating, at the computing system, a score for a degree of substitutability between items within the collection of heterogeneous items (step 504). Each item within the collection of heterogeneous items includes a plurality of attributes defined in an item data collection and unique from other items within the collection of heterogeneous items. To calculate this score, a plurality of items are selected from the collection of heterogeneous items for which transaction data exists. An edge weight is calculated for each of a plurality of pairs of items based on the transaction data. The plurality of pairs of items include each of the plurality of items relative to each other item within the plurality of items.

As discussed above, the score for a degree of substitutability between items, or edge weights, can be calculated in a number of ways. In one example, an association score can be calculated. An association score between two items A, B, can be defined as (analogously to the equation for AS above):

$$q ( A , B ) = \frac{n ( A , B ) * N}{n ( A ) * n ( B )}$$

In this statement of the association score, n(A) is the number of users who bought item A, n(B) is the number of users who bought item B and n(A, B) is the number of guest who bought both items. Association scores are measured for every pair of items that appear in a sufficient number of transactional histories of users. A high association score between a pair of items implies a user who selected one of the items in the past has a high chance of having selected the second item than a typical user for that second item. A low association score between a pair of items implies if a user selected one of the items in the past then there is a lower chance of the user selecting the second item than a typical user for that second item.

Using this notation for the association score, in general, the rate of transfer of demand between items A, B, can be defined as follows:

$$R ( A \to B ) = \frac{q ( A , B )}{sum ( C \text{:} q ( A , C ) )}$$

Items B with high R(A→B) can therefore be considered as a substitutable item set for A and all such items C with low R(A→C) as a non-substitutable item set for A. Accordingly, the rate of transfer out of A to B can be characterized by:

$$R ( A \to B ) = \frac{q ( A , B )}{sum ( B \text{:} q ( A , B ) ) + sum ( C \text{:} q ( A , C ) )}$$

While the rate at which demand does not transfer to another item C is depicted as:

$$R ( A \to A ) = \frac{sum ( C \text{:} q ( A , C ) )}{sum ( B \text{:} q ( A , B ) ) + sum ( C \text{:} q ( A , C ) )}$$

In a simplistic example associated with products sold in a retail scenario, a chocolate chip and pecan cookie might be sold. However, demand for that cookie may or may not transfer to a plain chocolate chip cookie of the same brand, or a ginger snap cookie of a different brand, or still further a sugar-free chocolate chip cookie of a different brand. In example experimental results, these alternatives have decreasing association scores, and corresponding decreasing sales transferring out to those alternative products.

As noted above, alternative methodologies, for example calculating demand transfer coefficients using a correlation score, could be used as well. In situations where a correlation score is considered, a Pearson correlation might be utilized, either in place of the association score, or to validate the association score by assessing a correspondence between the association score and correlation score.

Furthermore, it is noted that strength of the association between two items can be calculated in a number of ways, such as use of Jaccard coefficients, or collaborative filtering techniques. The tuning of such coefficients can define the number of substitution groups formed, and level of substitutability within each group.

In performing the above demand transfer analysis, calculation of demand transfer, as represented by edge weights and demand transfer coefficients, can be based on any of a variety of types of transaction data. In some examples, edge weights are calculated based on overall transaction data across a plurality of users. In such situations, there may also be seasonal effects to such demand, and therefore the data is typically detrended and deseasonalized prior to calculating edge weights and/or demand transfer coefficients.

Furthermore, the calculation of demand transfer can be performed at a more granular level as well, i.e., on a location-specific, region-specific, or even user-specific basis (assuming adequate transaction data associable with a particular location or user). It is noted that, at least at the individual user level, a challenge with such modeling is differentiating between sets of transactions that indicate substitution behavior and other sets of transactions that represent the user's selections within a heterogeneous category having different choice sets. Furthermore, the user may be a proxy for multiple users (if that user's selections are, for example, representative of household selections) and therefore model household activity, rather than individual user activity.

Optionally, the substitutability scores for each of the plurality of pairs of items within the collection of heterogeneous items are graphed (step 506). In some embodiments, a graph is displayed on a display, such as the display 232 of FIG. 3. In general, the construction of a graph is straightforward once the pairwise associations from demand modeling or pairwise correlation from item level data is obtained. Nodes represent items and edges represent association/correlation between pairs of items. The graph should be sparsified, for example by repeated sampling, to obtain a stable version of the graph, and to remove spurious associations or correlations.

In the example shown, a community detection algorithm is applied to the edge weights to identify a plurality of substitution groups (step 508). Graph partitioning and community detection algorithms can be used to decompose the graph into substitution groups. The community detection algorithms use the difference between fractions of edges that end within a partition and expected fraction of edges contained in the same partition for a random graph, to generate substitution groups within the collection of items and edge weights. To define substitution groups among the items graphed, the demand outflow from the substitution group to other nodes in the graph should be zero, or smaller than a specified tolerance (meaning that there is little outflow of demand to those items that are not within the substitution group).

Once substitution groups are formed, preferred attributes common to two or more items within one or the plurality of substitution groups are identified (step 510). Preferred attributes are attributes common to the items in the substitution group. Substitutable attributes are also identified. Substitutable attributes are attributes that differ between the items in the substitution group. This process, also referred to as item attribute clustering, allows for analysis of the types of products that might be considered substitutable for one another, for example for purposes of adding/subtracting items from an overall item assortment. Furthermore, because transaction data both at the user and item level can be very sparse and may not allow parameters to be estimated reliably for many items, this provides an additional method for aggregating items into substitution groups even when transaction data is lacking. Product grouping using item attribute clustering provides a powerful way to triangulate the discovery of substitution groups. For example, in some situations, brand name or flavor may be an identifiable item attribute that is common among items in a substitution group. As more item attribute data is included in analysis, additional trends among the items can be detected in terms of preferred and substitutable attributes.

Additionally once substitution groups are formed, demand transfer coefficients can be calculated between each of the items in a substitution group (step 512). In an example implementation, a conditional regression is applied to the items in each substitution group to determine a demand transfer coefficient for each item. In an alternative arrangement, the demand transfer coefficients can be generated by a conditional regression applied across the entire assortment, rather than within an individual substitution group.

Once demand transfer coefficients are obtained, the method 500 can include updating the item assortment (step 514). This updating of an item assortment is based at least in part on substitutability of the plurality of items within at least one of the plurality of substitution groups, as defined by the demand transfer coefficients. Updating the item assortment can include considering whether to add or remove items from an overall item assortment or individual substitution group.

In some embodiments, a rank order of preference of items within a substitution group for each of a plurality of users is determined based on transaction data, and an overall aggregate preference rank for the substitution group is calculated. The rank order preference within a substitution group illustrates popular or unpopular items within that substitution group, and can direct decisionmaking with respect to whether an item is added or removed from that substitution group. As noted above, each user may have a different preferred substitution pattern preferring one product over the other strongly and may substitute their favorite item when it becomes unavailable with others. Such users might only consider a small set of alternatives, each with an increasing penalty of goodwill. In such a case, a ranking order may be induced by guest behavior. A general depiction of a rank ordering arrangement for particular guests and items is illustrated in Table 2, below:

TABLE 2
Ranked Selections in Substitution Group by User

| | Item Rank | | | | |
|---|---|---|---|---|---|
| UserID | Item 1 | Item2 | Item3 | . . . | Item n |
| User1 | 1 | 3 | 12 | . . . | 4 |
| User2 | 3 | 2 | 4 | . . . | 20 |
| User3 | 1 | 2 | 3 | . . . | 7 |
| . . . | . . . | . . . | . . . | . . . | . . . |
| User n | 1 | 5 | 2 | . . . | 3 |

This ranking can be used to determine which items should be included from a choice set, and can also be used as a diagnostic tool that can check the result set of an optimization procedure which uses demand transferability coefficients. For example, if item N in the above table has a relatively low preference ranking and is readily substitutable for other items within a substitution group, it would be likely able to be removed from the overall item assortment, thereby freeing space for other items that would better optimize overall demand.

Referring now to FIG. 6, one possible method 600 for updating an item assortment is described in further detail, in association with adding an item to the overall item assortment. The method 600 includes identifying one or more attributes of an item (step 602), and a substitution group matching the one or more attributes of the item is identified (step 604). The substitution group matching the attributes can be, for example, a substitution group having preferred attributes in common with the item under consideration to be added to the item assortment.

In the example shown, an edge weight between the item under consideration to be added, and the items already included in the substitution group, is imputed (step 606). In example embodiments, this edge weight is imputed by assigning an average edge weight between pairs of items in the substitution group to each of a plurality of item pairs, the plurality of item pairs including the item under consideration to be added to the substitution group and a different one of the items included in the substitution group. In some embodiments, the edge weight is imputed by applying a machine learning model based at least in part on one or more attributes of the item as compared to attributes of the items included in the substitution group.

Once the edge weight is imputed for the item under consideration, an analysis can be performed (e.g., by ranked ordering of edge weights, or other methods) to determine whether the item should be added to the item assortment, in a manner consistent with the analysis above.

Currently the model output shows the textual attributes obtained from the description of the item contribute more towards differentiation of the substitution group than the structured attributes which are sparse at present. As a consequence if the description of a new item uses different vocabulary than what is presently available for the items in the training dataset then the model would fail to assign this new item to a substitution group. To resolve this issue it is essential to build structured attributes tables of high quality for all items including new items.

Referring to FIGS. 7A and 7B, example methods are illustrated for removing an item from an item assortment. When an item is removed from an assortment, its demand is expected to transfer to other items in the category with similar attributes or utility which may be viewed by a guest as a viable substitution with varying degrees of substitutability. A demand transfer model attempts to provide a measure of relative proportion of demand transferred from the item removed to each of the items that substitute for the removed item. The output of the model is a demand transfer matrix whose elements are the demand transfer coefficients that measure the degree of demand transferability between each pair of items in the category.

It is commonly assumed, but not necessarily true, that the demand between pairs of products in the group is negatively correlated. More often than not, a substitution group may be a simply connected graph with undirected, potentially asymmetric and directed demand flows. Accordingly, individual demand transfer should be assessed. The method 700 in FIG. 7A uses aggregate preference rankings to determine which item(s) to remove from an item assortment. The method 750 in FIG. 7B uses demand transfer coefficients (which are unidirectional between pairs of items) to determine which item(s) to remove from an item assortment.

Referring first to FIG. 7A, that method 700 includes determining an aggregate preference rank for all items within a substitution group for each user (step 702), as described above. The method 700 can also include determining an overall aggregate preference rank for all items in the substitution group for all users (step 704). The lowest ranking items within the substitution group are then identified (step 706), and those items having a lowest aggregate preference rank are removed from the item assortment (step 708).

Analogously in FIG. 7B, that method 750 includes applying a conditional regression to items within a substitution group (step 752), and calculating a demand transfer coefficient for each item (step 754). A threshold is determined for the demand transfer coefficient (step 756), for example by determining a level at which demand transfer is unlikely to occur. Accordingly, one or more items having a demand transfer coefficient above the set threshold, indicating that little to no demand transfer is likely to occur, can be removed from the item assortment (step 758).

Although FIGS. 7A-7B illustrate two possible methods for removing items, it is recognized that other methods could be utilized as well. For example, the aggregate preference rank and conditional regression could be combined, or presented to a user for selection and modification of the item collection. Other possibilities, using other mathematical methodologies, are available as well.

Referring now to FIGS. 8-17, a particular application of the methods and systems described above is presented, in the context of a retail location, such as an online or brick-and-mortar retailer. FIG. 8 is an example schematic illustration of a system 800, which is analogous to system 100 but placed within the retail context. In particular, a location 802 will include a product assortment 804 that can be selected by a user, or customer 808, with the customer's selections being captured at a point of sale device 806. The customer 808 represents either a single customer or a heterogeneous collection of customers each having unique product preferences.

As illustrated in FIG. 8, transaction data 820 from the point of sale device 806 can be transmitted to a server 812 for storage and analysis. A computing system 814, communicatively connected to the server 812 via a network 810, can display various analyses of the product assortment 804, for example based on selections by various customers at one or more locations 802. The computing system 814 can be one example implementation of computing system 114 of FIG. 1.

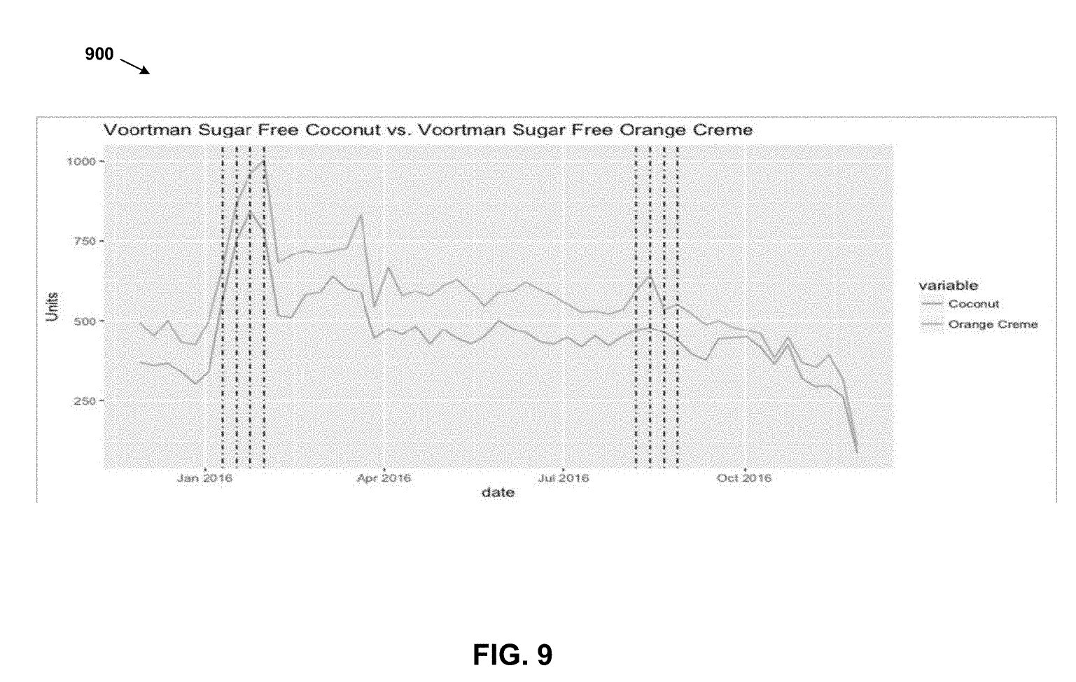

In this context, it is noted that demand transfer analysis can be performed on example transaction data captured from one or more point of sale devices 806. As illustrated in FIG. 9, a chart 900 illustrating transaction data for a particular pair of items is presented. The transaction data includes items sold over a period of time to a plurality of different users, and as such represents overall demand for those products. It is noted that the transaction data illustrated in the chart 900 could represent data for a particular retail location, or sales region.

As illustrated in this transaction data, some correlation among the sales of two types of products, in this case coconut and orange creme cookies, is seen. In this example, demand transfer for cookie items within the snacks department of a retail store is analyzed. Transaction data for a year of sales was utilized as input. This transaction data was separated into transactions by guest and transactions by item. In one year, there were over 13 million guests in the guest transaction data and over 71 million transactions in the item sales data. There was sales data for 707 distinct cookie items during that year.

It is noted that in the example shown, promotions for both types of cookies were provided during the time range of January-February 2016, but only the orange crème cookies were promoted in August-September 2016. Accordingly, that data would be de-trended or removed from the item substitutability analysis.

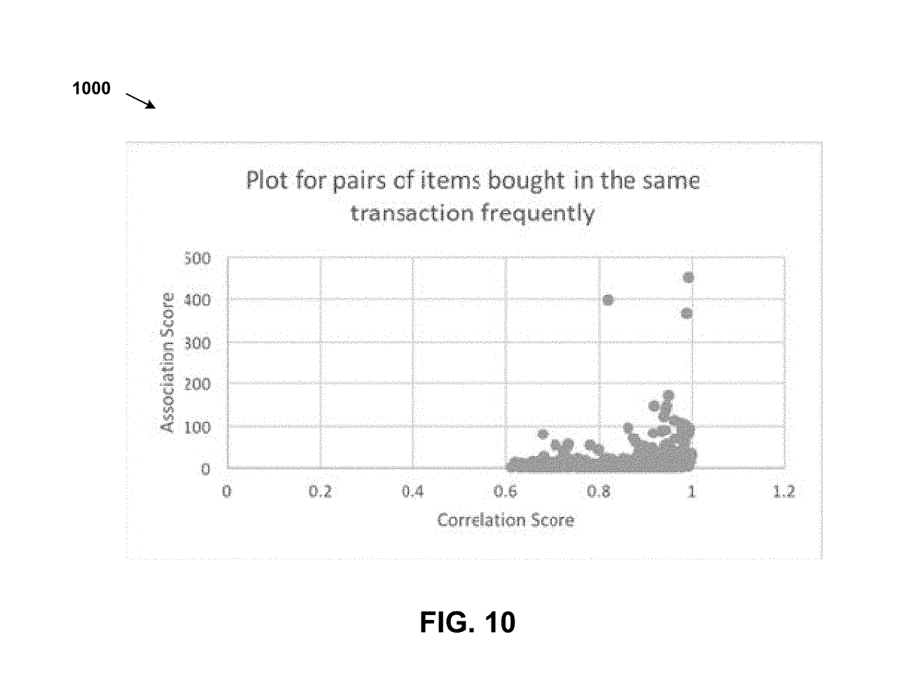

Continuing the illustration using the item data depicted in FIG. 9, a chart 1000 in FIG. 10 illustrates a correlation between association scores calculated between the two types of cookies and Pearson correlation scores that were similarly calculated. As can be seen in the chart 1000, a strong correlation is seen in both scoring methods, in that the items are often purchased together in the same transaction, and are of the same brand but differing flavor. Accordingly, in item categories where customers tend to buy potentially substitutable items within the same transaction since they are perhaps seeking variety, a positive correlation of demand between such substitutable item pairs can be seen.

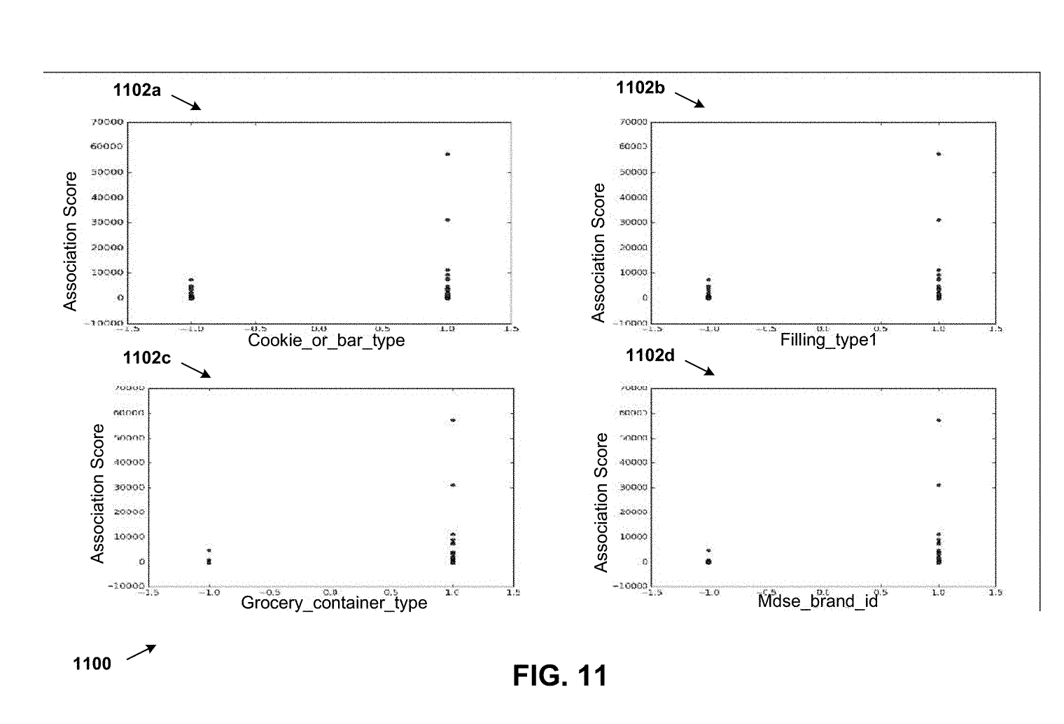

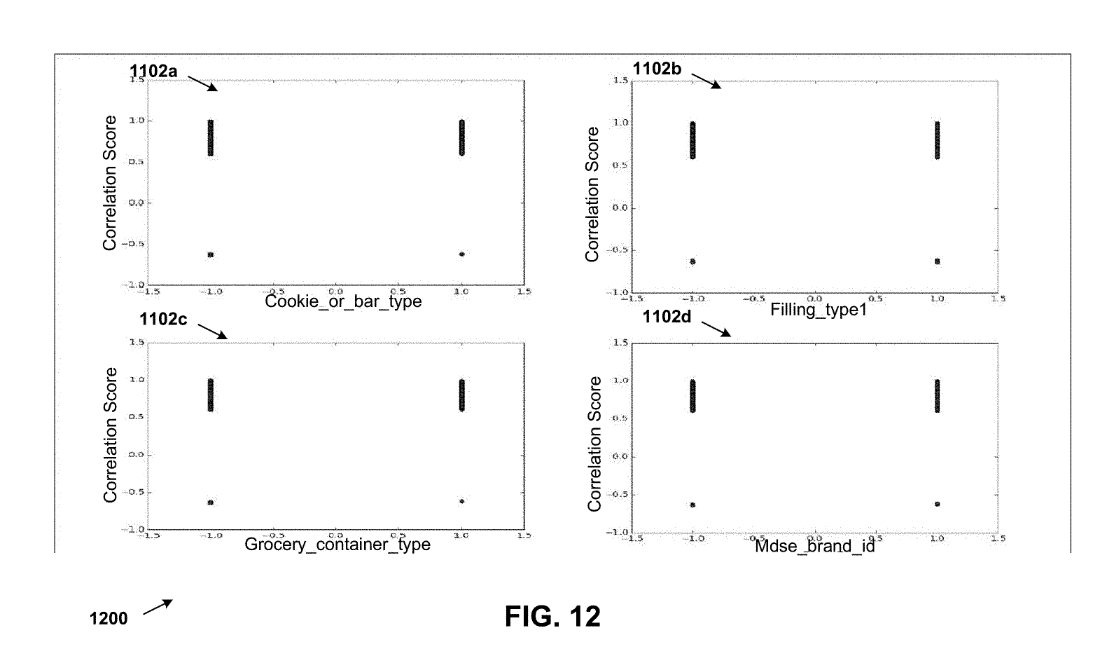

Continuing with FIGS. 11-12, four-part graphs 1100, 1200 illustrating similarity and dissimilarity of four structured attributes are shown. The four parts of these graph 1102a-d, 1202a-d, illustrate association scores and correlation scores representing four different attributes (cookie type, filling type, container type, and brand, respectively). The association scores and correlation scores are calculated as described above in conjunction with FIGS. 3-5.

As seen in FIG. 11, association scores are low for items having a mismatch of corresponding attributes, indicating that association scores are sensitive to each of these attributes. However, as seen in FIG. 12, correlation scores are high and appear indifferent to these attributes. As such, in some cases, validation of association scores with correlation scores can be helpful in assessing whether correlations in sales of one item might be affected by a change to another item (e.g., if sales of orange crème cookies would be adversely affected by addition or removal of coconut cookies of the same brand).

The output created by graphing association scores and correlation scores in FIGS. 11-12 are shown in Table 2. There was partial concordance between the two graphs created from the two scoring methodologies. The graph created from association scores can potentially create singleton communities.

TABLE 3
Comparison of Substitution Graphs

| | | Number of | Number of | Number of |
|---|---|---|---|---|
| Score Type | Modularity | Nodes | Communities | Singletons |
| Association | 0.95 | 530 | 282 | 240 |
| Correlation | 0.80 | 211 | 89 | 66 |

The substitution groups are utilized to identify attributes of items that distinguish each group from other groups. These are “preferred attributes” while all other attributes are candidates for “substitutable attributes.” These other attributes vary across items in the substitution group.

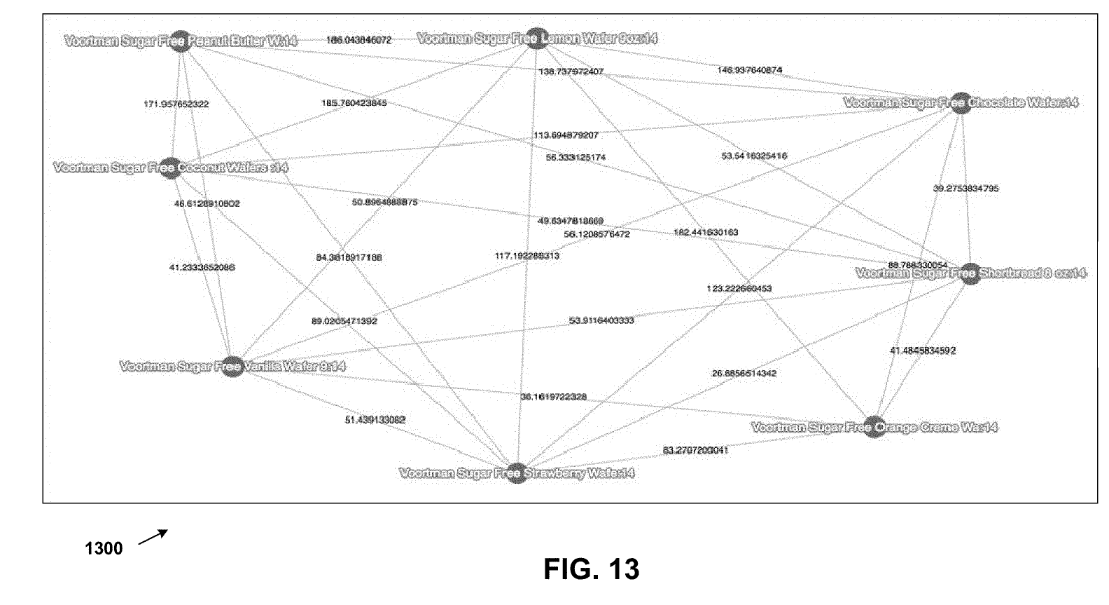

FIG. 13 illustrates an example graph 1300 that can be calculated from association scores within a particular substitution group (in this case, sugar free cookies of a particular brand). In this example, edge weights between each item within the substitution group are shown. The edge weights correspond to association scores derived from the sample transaction data from which the chart 900 of FIG. 9 was based.

As seen in FIG. 14, a chart 1400 illustrates the extent to which various attributes of the items included in the substitution group of FIG. 13 contribute to the items being within the same substitution group, in ranked order. As seen in this chart, attributes of each item can be merged from item attribute data into the transaction data, with textual attributes assigned numerical values for simplicity. Using a one-vs-all classification, items within a particular substitution group are assigned a label, and a logistic regression is performed. Each classification model results in a coefficient vector over the set of attributes. The coefficient vectors represent the contribution of the particular attribute to the item being within the substitution group, and when rank-ordered, it can be seen that certain attributes represent preferred attributes. In the case of the chart 1400, it is seen that the sugar-free characteristic, specific brand, and cookie type (wafer or shortbread) represent preferred attributes, while to some extent the specific flavors represent substitutable attributes.

Referring now to FIG. 15, and continuing the example of above, within the substitution group, a plurality of demand transfer coefficients is generated, and included in a graph 1500 showing pairwise substitutability among the items in the substitution group. These demand transfer coefficients represent the fraction of demand that will transfer from a product if it is removed from an assortment to other items that belong to the same substitution group and the fraction that will contribute to lost sales. In an alternative arrangement to using the demand transfer coefficients as seen in FIG. 15, conditional regression can be used within a substitution group, as noted above.

As seen in comparison to the graph of FIG. 13, where the graph 1300 is bidirectional and describes a score correlating each item to each other item, the graph 1500 is indicated as unidirectional, and each correlation (shown as lines between products) includes an arrowhead indicating the direction in which demand transfer flows, as well as the demand transfer coefficient associated therewith.

FIG. 16 illustrates a graph 1600 showing results of validation of the demand transfer coefficients obtained from the association scores with coefficients from the conditional regression models. As seen in the graph 1600, both the Pearson and Spearman correlations between the demand transfer coefficient and the regression coefficient are positive, and moderately high for different values of the regularization parameter λ. This indicates that the degree of substitution captured by the demand transfer coefficient across pairs of items are similar to that captured by the conditional regression coefficients for all values of the regularization parameter λ. Since, higher values of the regularization parameter lambda force more beta values to become zero for items within the substitution group, we see fewer data points for λ=0.25, 0.5 as compared to λ=0.1.

Referring to FIG. 17, a rank aggregation interface 1700 is seen, using the continued example data described herein with respect to FIGS. 9-17. In the rank aggregation interface 1700, within a particular substitution group and preference ranking, there is also a frequency of purchase of an item. The rank aggregation interface 1700 can display a ranking based, for example, on at least one of a mean rank, geometric mean rank, and runoff-based aggregation. Generally, although aggregate preference rankings do not always match sales-based rankings. For example, in the interface 1700 associated with sugar free wafer cookies, it can be seen that the vanilla brick waver cookie (shown last in the list) has a highest ranking based on revenue, but is ranked third based on the aggregate measure of how often it is purchased by the guest who frequently buys within this substitution group. Other observations can be derived from such rank aggregations that depart from sheer transaction volumes, which assist in making item assortment management decisions.

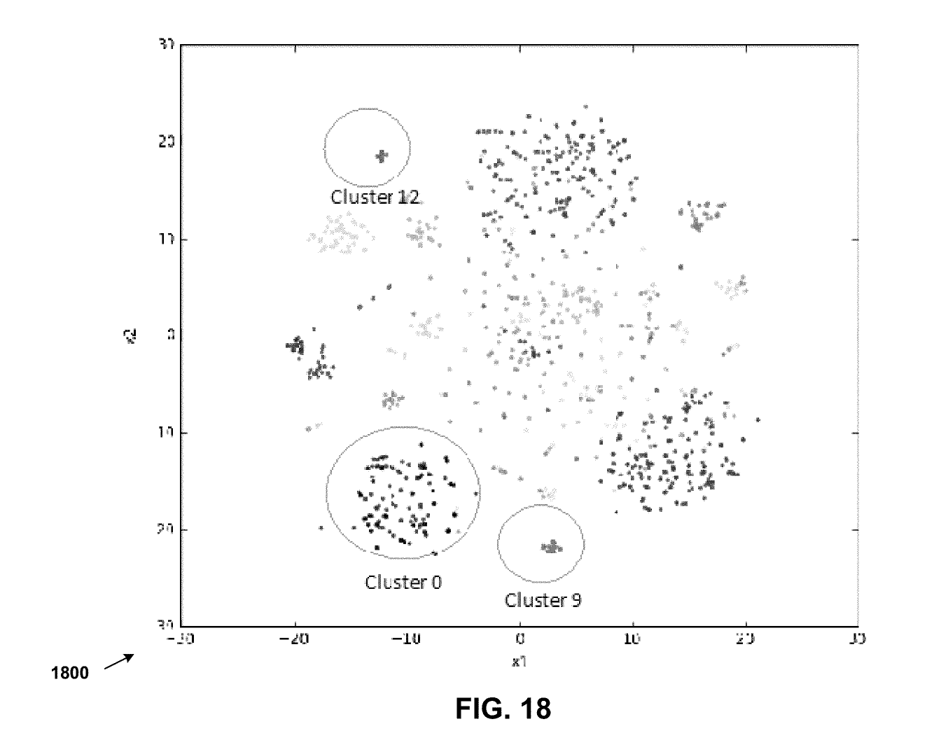

Referring now to FIGS. 18-20, additional details are provided regarding a possible manner of clustering of items, within the context of a retail environment, according to alternative embodiments. As illustrated in these drawings, a further example of identifying possible substitution groups is provided based on clustering, in which item attribute similarity can be analyzed.

Referring first to FIG. 18, a graph 1800 depiction of clustered products based on sales transaction data is shown. The graph 1800 illustrates item attribute clusters obtained within a class of products (cookies), in which tokenized words derived from the item name and description are used to determine similarity. The determination as illustrated is performed using a set of unigrams (in this case, 1396 unigrams were generated) using a non negative matrix factorization technique. As seen in that graph 1800, use of name and description allows for a grouping of items by brand. Three example substitution groups, denoted by clustered items (shown as “Cluster 0”, “Cluster 9”, and “Cluster 12”, respectively) show good separation from other items within an overall item assortment.

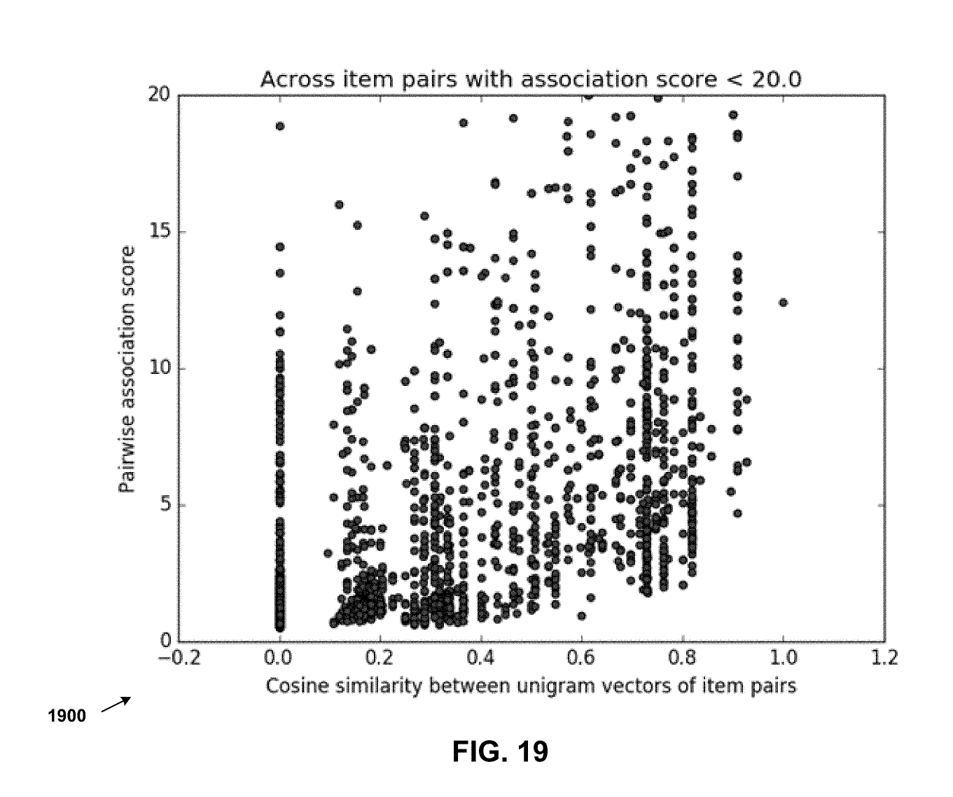

FIG. 19 illustrates a cosine similarity graph 1900 representing a correlation between the pairwise association score between two items based on sales data and the cosine similarity between unigram vectors of item pairs based on the tokenized item attribute information. As seen in the graph 1900, although the data is noisy, the trend toward greater correlation between demand association scores and the similarity score is clear. This illustrates, and validates the observation from FIG. 18 that from the perspective of grouping items into substitution groups, use of attribute-based similarity scores is a reasonable proxy for use of sales data, as is discussed above. Alternative depictions of such data could take the form of a heat map illustrating a pairwise association score relative to cosine similarity, also showing such correlation.

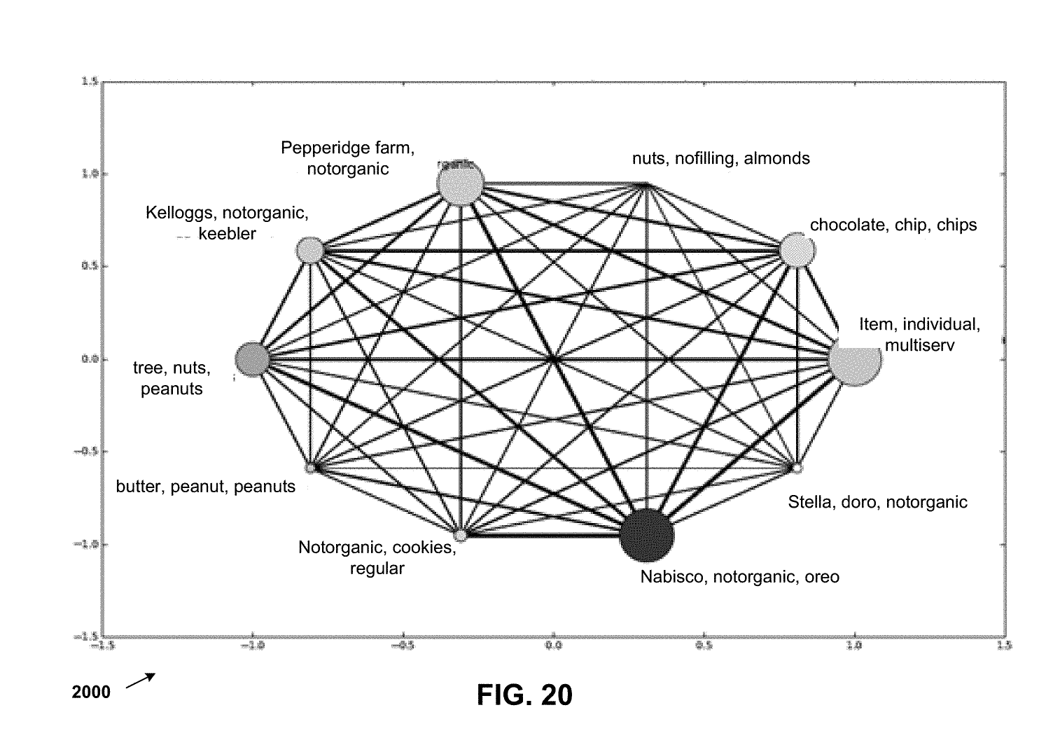

FIG. 20 illustrates an item attribute based similarity graph 2000, according to the example of FIGS. 18-20, in which specific attributes are grouped for purposes of a specific number of demand pairs in existence having substitutable attributes. As illustrated in the graph 2000, each node represents a collection of attributes determined to be substitutable, with the size of each node corresponding to the number of item pairs falling within that node.

In example applications, the items within each grouping can be placed in a rank order according to guest preference, as is illustrated in Table 2, above. Furthermore, once such groups are created, demand transfer coefficients can be used among the items in an identified substitution group to determine substitutability for purposes of modifying the selected assortment (e.g., adding, removing, or adjusting inventory amounts of items included in the assortment).

Referring to FIGS. 1-20 generally, it is noted that the present methods and systems for analyzing demand transfer, and accordingly managing item assortments, can have a number of applications, each of which has advantages.

As can be seen herein, the substitution behaviors found in the sales transaction data can be used to understand demand transferability and afford both an opportunity to learn substitution behavior. Importantly, having many variants of products to choose from is important, because as the number of variants of a product goes up, the probability of “no buy” goes down dramatically and the need for safety stock for any of the variants is also minimized.

Furthermore, as noted above, demand transfer for different populations of users or groups of stores/locations can be performed, based on the transaction data that is selected for analysis. Furthermore, for those specific users/locations, item assortments can be optimized by predicting, based on item attributes, a change in demand for a particular item if it were added to or removed from an overall item assortment. Furthermore, because the present approach is driven by data rather than assumptions as to user behavior, the grouping of items within the substitution groups is automated and based on actual substitutability, rather than a perception of substitutability by item assortment planners, leading to improved accuracy in item assortment optimization. Furthermore, both attribute based regression of item demand and attribute based regression of pairwise demand association may not only help automate the discovery of critical attributes to demand transfer, but also help quantify their influence.

Furthermore, each user may have a preferred substitution pattern preferring one product over the other strongly and may or may not substitute their favorite choice or may only consider a small set of alternatives but each with an increasing penalty of goodwill. This clearly induces a rank ordering of the products substituted and asymmetric flow of demand. Based on the analysis provided herein, and enabled by the systems and methods of the present disclosure, is not clear that this ranking is reflected fully in the popularity of the products within a category.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A method of managing an item assortment from among a collection of heterogeneous items, the method comprising:
receiving, at a computing system, item data associated with the collection of heterogeneous items, the item data defining values for a plurality of item attributes of the collection of heterogeneous items,
calculating, at the computing system, a score for a degree of substitutability between items within the collection of heterogeneous items, each item within the collection of heterogeneous items including a plurality of attributes defined in an item data collection and unique from other items within the collection of heterogeneous items, wherein calculating the score includes:
selecting a plurality of items from the collection of heterogeneous items for which transaction data exists; and
calculating, at the computing system, an edge weight for each of a plurality of pairs of items, the plurality of pairs of items including each of the plurality of items relative to each other item within the plurality of items, the edge weight based on the transaction data;
applying a community detection algorithm to the edge weights to identify a plurality of substitution groups;
identifying preferred attributes common to two or more items within one of the plurality of substitution groups by:
identifying preferred attributes common to the items in the substitution group, and
identifying substitutable attributes of the items in the substitution group that are different; and
updating an item assortment based at least in part on substitutability of the plurality of items within at least one of the plurality of substitution groups.

2. The method of claim 1, wherein the transaction data comprises one or more of price data, promotions data, out of stock data, and item attribute data.

3. The method of claim 1, wherein the transaction data includes items not included within the collection of heterogeneous items; and wherein the relationship score is not calculated for items not within the collection of heterogeneous items.

4. The method of claim 1, wherein the transaction data comprises user transaction data associated with item selections by a plurality of users.

5. The method of claim 4, further comprising, after calculating the edge weights, performing a detrending and deseasonalizing on demand reflected in the transaction data to obtain residuals.

6. The method of claim 1, wherein the community detection algorithm optimizes a modularity of the items based on the edge weights to identify the plurality of substitution groups.

7. The method of claim 1, wherein the plurality of substitution groups each include one or more of the plurality of items.

8. The method of claim 1, wherein the edge weight for a pair of items within the plurality of pairs of items comprises a correlation score calculated based at least in part on a Pearson correlation between transactions associated with the pair of items.

9. The method of claim 1, wherein the edge weight for a pair of items comprises an association score calculated based at least in part on a probability that a transaction includes both first and second items within the pair of items divided by a product of first and second probabilities,
the first probability being a probability that a transaction includes a first item of the pair of items, and the second probability being a probability that a transaction includes a second item of the pair of items different from the first item.

10. The method of claim 9, further comprising comparing the association score with a correlation score calculated based at least in part on a Pearson correlation between transactions associated with the pair of items.

11. The method of claim 1, wherein the edge weight for a pair of items comprises an association score represented by a Jaccard similarity between first and second items within the pair of items.

12. The method of claim 1, further comprising applying conditional regression to the items in the substitution group to determine a demand transfer coefficient for each item.

13. The method of claim 12, further comprising validating the demand transfer coefficient by one or more of triangulation, bootstrapping, modularity, diagnostic plots, probabilistic measurement, and ranking of guest preferences.

14. The method of claim 12, further comprising generating a directed graph illustrating demand transfer coefficients among the items in the substitution group.

15. The method of claim 1, wherein updating the item assortment includes at least one of:
removing at least one item from the item assortment, the item assortment being a physical collection of items;
adding at least one item to the item assortment; or
updating the item assortment within a limited-capacity item storage environment.

16. The method of claim 15, wherein removing at least one item comprises evaluating an aggregate preference rank for all items within a substitution group and removing an item having a lowest aggregate preference rank.

17. The method of claim 15, wherein removing at least one item comprises applying conditional regression to the items in the substitution group to determine a demand transfer coefficient for each item and identifying one or more items having a demand transfer coefficient above a threshold.

18. The method of claim 15, wherein adding at least one item comprises:
identifying one or more attributes of the item;
identifying a substitution group matching the one or more attributes of the item;
imputing an edge weight between the at least one item and other items in the substitution group.

19. The method of claim 18, wherein imputing the edge weight between the item and the items included in the substitution group includes assigning an average edge weight between pairs of items in the substitution group to each of a plurality of item pairs, the plurality of item pairs including the item to be added to the substitution group and one of the items included in the substitution group.

20. The method of claim 18, wherein imputing the edge weight between the item and the items included in the substitution group includes applying a machine learning model based at least in part on one or more attributes of the item as compared to attributes of the items included in the substitution group.

21. The method of claim 1, further comprising determining a rank order of preference of items within a substitution group for each of a plurality of users based on transaction data and calculating an overall aggregate preference rank for the substitution group.

22. The method of claim 21, wherein the calculating is done with one of a mean rank algorithm, a geometric mean rank algorithm, and a runoff based algorithm.

23. The method of claim 1, further comprising constructing a graph representing each of the plurality of items and the edge weights between the plurality of pairs of items.

24. A system for managing an item assortment from among a collection of heterogeneous items, the system comprising:
a computing device including a processor, a memory communicatively coupled to the processor, and a content output device, the memory storing instructions executable by the processor to:
receive item data associated with the collection of heterogeneous items, the item data defining values for a plurality of item attributes of the collection of heterogeneous items;
calculate substitution scores between items within the collection of heterogeneous items based on transaction data associated with each item in the collection of heterogeneous items, each item within the collection of heterogeneous items including a plurality of attributes defined in an item data collection and unique from other items within the collection of heterogeneous items;
identify a plurality of substitution groups by applying a community detection algorithm to the substitution scores,
identify preferred attributes and substitutable attributes of the items within the substitution groups based on the item data, and
apply conditional regression to the items within the substitution group to determine a demand transfer coefficient for each item; and
updating an item assortment based at least in part on substitutability of the plurality of items within at least one of the plurality of substitution groups.

25. The system of claim 24, further comprising a data store comprising a transaction data store housing the transaction data, an item data store housing the item data, and a collection data store housing the item assortment.

26. The system of claim 24, wherein the transaction data comprises data for transactions at a guest level and/or an item level.

27. The system of claim 24, wherein the item data comprises data associated with at least one of attributes, prices, and promotions associated with each item.

28. The system of claim 24, wherein the substitution scores comprise at least one of correlation scores or association scores.

29. The system of claim 24, wherein preferred attributes are attributes common to the items within the substitution group and substitutable attributes are attributes that differ between the items within the substitution group.

30. The system of claim 24, further comprising displaying, on the content output device, a graph representing the plurality of substitution groups.

31. A non-transitory computer-readable storage medium comprising computer-executable instructions which, when executed by a computing system, cause the computing system to perform a method of calculating a demand transfer coefficient for an item, the method comprising:
receiving, at a computing system, item data associated with a collection of heterogeneous items, the item data defining values for a plurality of item attributes of the collection of heterogeneous items,
calculating, at the computing system, a score for a degree of substitutability between items within the collection of heterogeneous items, each item within the collection of heterogeneous items including a plurality of attributes defined in an item data collection and unique from other items within the collection of heterogeneous items, wherein calculating the score includes:
selecting a plurality of items from the collection of heterogeneous items for which transaction data exists;
calculating, at the computing system, an edge weight for each of a plurality of pairs of items, the plurality of pairs of items including each of the plurality of items relative to each other item within the plurality of items, the edge weight based on the transaction data;
graphing the substitutability scores for each of the plurality of pairs of items within the collection of heterogeneous items;
applying a community detection algorithm to the edge weights to identify a plurality of substitution groups;
identifying preferred attributes common to two or more items within one of the plurality of substitution groups by:
identifying preferred attributes common to the items in the substitution group, and
identifying substitutable attributes of the items in the substitution group that are different; and
applying conditional regression to the items in each substitution group to determine a demand transfer coefficient for each item.

32. A method of calculating a demand transfer coefficient for an item, the method comprising:
receiving, at a computing system, item data associated with a collection of heterogeneous items, the item data defining values for a plurality of item attributes of the collection of heterogeneous items,
calculating, at the computing system, a score for a degree of substitutability between items within the collection of heterogeneous items, each item within the collection of heterogeneous items including a plurality of attributes defined in an item data collection and unique from other items within the collection of heterogeneous items, wherein calculating the score includes:
tokenizing item name and item attribute data for a plurality of items from the collection of heterogeneous items for which transaction data exists;
graphing each of the plurality of items using a non negative matrix factorization to determine a plurality of substitution groups;
identifying preferred attributes common to two or more items within one of the plurality of substitution groups; and
applying conditional regression to the items in each substitution group to determine a demand transfer coefficient for each item.

33. The method of claim 32, further comprising validating the plurality of substitution groups by comparing the identified substitution groups to substation groups identified using transaction data.
